(19) United States
(12) Patent Application Publication
(10) Pub. No.: US 2024/0133137 A1
(43) Pub. Date: Apr. 25, 2024

(54) ROAD SAFETY BARRIER INSTALLER, SYSTEM AND RELATED METHODS

(71) Applicant: ROBOS INTERNATIONAL LIMITED, Auckland (NZ)

(72) Inventor: David Marshall HUDSON, Auckland (NZ)

(73) Assignee: ROBOS INTERNATIONAL LIMITED, Auckland (NZ)

(21) Appl. No.: 18/278,143

(22) PCT Filed: Feb. 22, 2022
(86) PCT No.: PCT/IB2022/051528

§ 371 Date: Aug. 20, 2023

(30) Foreign Application Priority Data
Feb. 22, 2021 (NZ) 773209

(51) Int. Cl. E01F 15/04

(52) U.S. Cl. CPC E01F 15/0484

(57) ABSTRACT

A road safety barrier installation system that uses a workstation and product support able to be guided by a truck along a road. The product supporter is adapted to receive a store of product such as ground penetrating anchors, posts and barrier strap. The workstation comprises at least one placement robot able robot able to receive and hold a said product, and position the so received and held product in location as part of the array.

The present invention relates to a road safety barrier installer, system and related methods. More particularly but not exclusively it relates to and automated road safety barrier installer, system and related methods.

### BACKGROUND

The installation of barriers such as road safety barriers adjacent to the carriage way of roads can be a time consuming process. It can also be a dangerous process, especially where the road is still in use by the public. Where the road is unable to be used during the barrier installation process, it is often important to ensure that the barrier installation process is conducted rapidly so that road closures are minimised. Typically a road barrier may be installed by concreting into the ground, spaced apart posts that a cable or cables are then attached to that extend along the barrier. The digging of holes and the concreting of the posts into the holes, including the cure time of the concrete, can take a long time. This is often largely a manual process and may take a number of people to perform. Those people installing such road barriers are also out on the road which, where the road is still being used by the public, can present dangers to the installers.

It may therefore an object of the present invention to provide a road safety barrier installer which overcomes or at least partially ameliorates some of the abovementioned disadvantages or which at least provides the public with a useful choice.

It may therefore an object of the present invention to provide a road safety barrier installer system which overcomes or at least partially ameliorates some of the abovementioned disadvantages or which at least provides the public with a useful choice.

It may also therefore an object of the present invention to provide a method of installing a road safety barrier which overcomes or at least partially ameliorates some of the abovementioned disadvantages or which at least provides the public with a useful choice.

### STATEMENTS OF INVENTION

In a first aspect the present invention may be said to be a multi-function road safety barrier installer for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array parallel to the road to define at least part of a road safety barrier, the road safety barrier installer comprising:
a. a prime mover able to travel along a road adjacent to an installation location where the road-safety barrier is to be installed,
b. a work station, able to move with and by the prime mover along the road adjacent to the installation location, the work station comprises a base and at least one placement robot able move relative to the base,
c. a product supporter, able to be moved by the prime mover with said work station along the road adjacent to the installation location, wherein the product supporter is adapted for storing, transporting and supplying to said at least one placement robot a plurality of ground screws and a plurality of posts and at least one barrier strap from at least one store containing at least one of:
   i. a plurality of ground screws,
   ii. a plurality of posts, and
   iii. at least one flexible barrier strap in a coiled format,
able to be supported simultaneously or sequential by said product supporter, to allow the sequential supply of ground screws and posts and barrier strap to said at least one placement robot to install in location adjacent said road, said ground screws and posts and said barrier strap.

Preferably the product supporter is adapted for storing, transporting and supplying to said at least one placement robot a plurality of ground screws and a plurality of posts and at least one barrier strap from at least two stores a first store containing a plurality of ground screws and a second store containing a plurality of posts, the first or second store also containing at least one flexible barrier strap in a coiled format.

Preferably the product supporter is adapted for storing, transporting and supplying to said at least one placement robot a plurality of ground screws and a plurality of posts and at least one barrier strap from at least two stores a first store containing a plurality of ground screws and a second store containing at least one flexible barrier strap in a coiled format, the first or second store also containing a plurality of posts.

Preferably the product supporter is adapted for storing, transporting and supplying to said at least one placement robot a plurality of ground screws and a plurality of posts and at least one barrier strap from three stores a first store containing a plurality of ground screws and a second store containing a plurality of posts and a third store containing at least one flexible barrier strap in a coiled format.

In a further aspect the present invention may be said to be a road safety barrier installer for installing an array of ground screw supported spaced apart posts that in concert support at least one barrier strap that extends along the array, the road safety barrier installer comprises:
a) a prime mover able to travel along a road adjacent to the location of the array,
b) a work station, towed by or part of or otherwise able to move with and by the prime mover, along the road adjacent to the location of the array,
c) a product supporter, towed by or part of or otherwise able to move with and by the prime mover and/or the work station, along the road adjacent to the location of the array,
   i. wherein the product supporter is adapted to receive one of (i) a single store of a plurality of product comprising of at least two of ground screws, posts and barrier strap and (ii) a plurality of stores, individually, of a plurality of product comprising of one of each of ground screws, posts and barrier strap, and
   ii. wherein the work station comprises:
      i) a base, towed by or part of or otherwise able to move with and by the prime mover, and
      ii) at least one placement robot able move relative to the base, the robot able to
         a. receive and hold a said product and
         b. position the so received and held product in location as part of the array.

In a second aspect the present invention may be said to be a road safety barrier installer for installing an array of ground screw supported spaced apart posts that in concert support at least one barrier strap that extends along the array, capable of being moved along a road adjacent to the location of the array by a prime mover, the road safety barrier installer comprises:
a) a work station, towed by or part of or otherwise able to move with and by the prime mover, along the road adjacent to the location of the array,
b) a product supporter, towed by or part of or otherwise able to move with and by the prime mover and/or the work station, along the road adjacent to the location of the array,
   A. wherein the product supporter is adapted to receive one of (i) a single store of a plurality of product comprising of at least two of ground screws, posts and barrier strap and (ii) a plurality of stores, individually, of a plurality of product comprising of one of each of ground screws, posts and barrier strap, and
   B. wherein the work station comprises:
      i) a base, towed by or part of or otherwise able to move with and by the prime mover, and
      ii) at least one placement robot able move relative to the base, the robot able to
         a. receive and hold a said product and
         b. position the so received and held product in location as part of the array.

In a further aspect the present invention may be said to be a method of installing road barrier, presented as an array of ground penetrating anchor supported spaced apart posts that in concert support at least one barrier strap that extends along the array, the method comprising
a) guiding a work station that comprises at least one placement robot along the road adjacent to the location of the array,
b) guiding at least one product supporter along the road adjacent to the location of the array, preferably coupled to or integrally formed or connected with the work station to move said work station, the product supporter(s) each or sequentially in time storing a plurality of product comprising of a plurality of ground penetrating anchor, posts and barrier strap
c) a said or each robot,
   a. in a first pass of the work station along the array, placing in sequence in the array, said ground penetrating anchors into the ground,
   b. in a second pass of the workstation along the array (whether that is a pass in the opposite direction of the first pass or the same direction), placing in sequence in the array, said posts onto each said placed ground penetrating anchor.

Preferably the or each robot, in a third pass of the workstation along the array (whether that is a pass in the opposite direction of the first pass or the same direction), securing along said array, at least one said barrier strap to each said placed post.

In a further aspect the present invention may be said to be a road safety barrier installation system for installing an array of ground penetrating anchor supported spaced apart posts that in concert are able to support at least one barrier strap or cable that extends along the array, the road safety barrier installer system comprises:
a) a work station, able to be guided for movement along the road adjacent to the location of the array,
b) at least one product supporter able to be guided for movement along the road adjacent to the location of the array, preferably coupled to or integrally formed or connected with the work station,
   A. wherein the product supporter is adapted to be able to support a store of a plurality of ground penetrating anchor and a store of a plurality of posts,
   B. wherein the work station comprises at least one placement robot able robot able to
      a. receive and hold a said product, and
      b. position the so received and held product in location as part of the array.

Preferably the product supporter is adapted to be able to support a store of a plurality of ground penetrating anchor and a store of a plurality of posts and a store of barrier strap or barrier straps.

Preferably the product supporter is adapted to receive one of (i) a single store of a plurality of product comprising of a plurality of ground penetrating anchor, posts and barrier strap and (ii) a plurality of stores, individually, of a plurality of product comprising of one of each of ground penetrating anchor, posts and barrier strap.

Preferably the road safety barrier installer is able to releasably connect the work station and product supporter to a prime mover.

Preferably the road safety barrier installer includes the prime mover.

In a further aspect the present invention may be said to be a road safety barrier installation system for installing an array of ground anchor supported spaced apart posts that in concert support at least one barrier strap that extends along the array, the road safety barrier installation system comprises:
a) a prime mover able to travel along a road adjacent to the location of the array,
b) a work station, towed by or part of or otherwise able to move with and by the prime mover, along the road adjacent to the location of the array,
c) a product supporter, towed by or part of or otherwise able to move with and by the prime mover and/or the work station, along the road adjacent to the location of the array,
   A. wherein the product supporter is adapted to receive one of (i) a single store of a plurality of product comprising of at least two of ground anchor, posts and barrier strap and (ii) a plurality of stores, individually, of a plurality of product comprising of one of each of ground anchor, posts and barrier strap, and
   B. wherein the work station comprises at least one placement robot able move relative to the base, the robot able to
      a. receive and hold a said product, and
      b. position the so received and held product in location as part of the array.

Preferably product as used herein comprises of at least one of a ground screw, post and barrier strap.

Preferably the at least one robot comprises at least one arm able to move relative to the base, the arm having a distal end adapted to receive or having a tool:

a) for receiving and holding a product from the product supporter, and
b) for positioning the so received and held product in location as part of the array.

Preferably the robot is a pick and placement robot.

In a further aspect the present invention may be said to be a road safety barrier installation system for installing an array of ground screw supported spaced apart posts that in concert support at least one barrier strap that extends along the array, the road safety barrier installation system comprises:
a) a prime mover able to travel along a road adjacent to the location of the array,
b) a work station, towed by or part of or otherwise able to move with and by the prime mover, along the road adjacent to the location of the array,
c) a product supporter, towed by or part of or otherwise able to move with and by the prime mover and/or the work station, along the road adjacent to the location of the array,
   A. wherein the product supporter is adapted to receive one of (i) a single store of a plurality of product comprising of at least two of ground screws, posts and barrier strap and (ii) a plurality of stores, individually, of a plurality of product comprising of one of each of ground screws, posts and barrier strap, and
   B. wherein the work station comprises:
      i) a base, towed by or part of or otherwise able to move with and by the prime mover, and
      ii) at least one arm able to move relative to the base, the arm having a distal end adapted to receive or having a tool:
         a. for receiving and holding a product from the product supporter, and
         b. for positioning the so received and held product in location as part of the array.

Preferably the prime mover is able to travel on at least one of the carriage way of the road, the berm to the road, the median strip of the road, the emergency lane of the road.

Preferably the prime mover is an automotive vehicle whether it's is electrically powered or by fossil fuel.

Preferably the automotive vehicle is a truck.

Preferably the automotive vehicle is a truck with a truck body presenting a cabin and a cargo area or towed trailer with a cargo area to the rear of the cabin.

Preferably the cargo area is where at least the work station is positioned.

Preferably the cargo area is where at least the work station is receive or receivable.

Preferably the cargo area is where the product supporter is located or able to be located or received.

Preferably the product supporter is or is part of one of (a) a trailer and (b) the truck.

Preferably the work station is or is part of a one of (a) a trailer and (b) the truck.

Preferably the product supporter and the work station is or is part of one of a road trailer.

Preferably the work station and the work station is or is part of a one of the truck.

Preferably the cargo area is or is part of one of (a) a trailer and (b) the truck.

Preferably the trailer is a semi-trailer.

Preferably the trailer is able to be towed by the prime mover (eg the truck).

Preferably the trailer is able to releasably couple to the prime mover (eg the truck).

Preferably the prime mover is able to be steered for directional control of the prime mover and the cargo area for travel along the road.

Preferably the prime mover is able to be automatically steered.

Preferably the prime mover is able to be automatically steered utilising a positioning system.

Preferably the prime mover is able to be automatically steered utilising a satellite positioning system.

Preferably the prime mover is able to be automatically steered utilising a global positioning system.

Preferably the prime mover is able to be automatically steered utilising a global navigation satellite system.

Preferably the prime mover is able to be automatically steered utilising a local positioning system.

Preferably the prime mover is able to be automatically steered utilising an optical sensor or sensors or radar.

Preferably the prime mover is able to be automatically steered utilising a programmable coordinate programme.

Preferably the prime mover is able to be automatically steered utilising anyone or more of a combination of the above means.

Preferably one or more of each store of plurality of product is a containerised store.

Preferably each containerised store holds and allows sequential dispensing of product therefrom to the work station.

Preferably each containerised store holds and allows sequential dispensing of product therefrom to the tool.

Preferably each containerised store allows reloading of product.

Preferably product is held by the containerises store in at least one array of product.

Preferably the or each array is a stack or column of product.

Preferably product is dispensed from the stack or column from the bottom thereof.

Preferably a transfer arrangement is provided to transfer product from the product supporter to the work station.

Preferably a transfer arrangement is provided to transfer product from the containerised store to the work station.

Preferably a transfer arrangement is provided to transfer product from the containerised store to a respective tool.

Preferably the transfer arrangement is located intermediate of the array of product and the respective tool.

Preferably the work station comprises a base, towed by or part of or otherwise able to move with and by the prime mover, and

Preferably the transfer arrangement is able to take or receive a product of the store and move it to the tool.

Preferably the transfer arrangement is able to take or receive a product of the store and present it for engagement by the tool.

Preferably the transfer arrangement is able to take or receive a product presented at a loading zone of the workstation at where the tool is able to retrieve said product for subsequent movement to locating the product as part of the array.

Preferably one of said tools is a ground screw driving tool.

Preferably the ground screw driving tool is able to connect to (e.g. the end of) each ground screw when presented at the work station.

Preferably the ground screw driving tool is able to connect to the end of each ground screw when presented at the loading zone.

Preferably the ground screw tool is able to cause a connected ground screw to rotate relative to the arm to cause the ground screw to embed into the ground at a desired location along the array.

Preferably one of said tools is a post connection tool able to move a post to position it and preferably connect it to a ground embedded ground screw.

Preferably the post connection tool is able to connect to (e.g. the end of) each post when presented at the work station.

Preferably the post connection tool is able to connect to the end of each post when presented at the loading zone.

Preferably the post connection tool is able to cause a connected post to be manoeuvred to connect to a ground embedded ground screw.

Preferably the post connection tool is able to cause a connected post to have its free distal end be manoeuvred to connect to a ground embedded ground screw.

Preferably one of said tools is a barrier strap connection tool able to move a barrier strap to position it and preferably connect it to each post of the array.

Preferably the barrier strap connection tool is able to receive a continuous feed of barrier strap.

Preferably the barrier strap connection tool is able secure barrier strap at a predetermined height to each post of the array.

Preferably the barrier strap connection tool is able to receive a feed of a plurality of barrier straps.

Preferably the barrier strap connection tool is able to receive a feed of at least two barrier straps.

Preferably the barrier strap connection tool is able to receive a feed of at least three barrier straps.

Preferably the plurality of barrier straps are secured in parallel each other to each post in the array along the array.

Preferably one of said tools is a post driving tool able to move a post with a ground screw at its free distal end to position it into ground along the road.

Preferably the ground screw may be a ground anchor. It may for example be a vibration driven anchor instead of a screw driven anchor.

Preferably the post connection tool is able to connect to (eg the end of) each post when presented at the work station.

Preferably the post connection tool is able to connect to the end of each post when presented at the loading zone.

Preferably the post connection tool is able to cause a connected post to be manoeuvred to connect to a ground embedded ground screw.

Preferably the post connection tool is able to cause a connected post to have its free distal end be manoeuvred to connect to a ground embedded ground screw Preferably the arm is mounted to the base in an articulated manner.

Preferably the arm is able to move the tool connected at the end of the arm relative to the base.

Preferably the robot is able to move the tool connected at the end of the arm relative to the base.

Preferably the arm is able to move the tool connected at the end of the arm relative to the base to position product held or guided by said tool into location to said array.

Preferably the robot is able to move the tool connected at the end of the arm relative to the base to position product held or guided by said tool into location to said array.

Preferably arm is mounted to the base by or as part of a parallelogram mechanism.

Preferably robot comprises or is a part of a parallelogram mechanism.

Preferably the arm can be caused to move laterally to the direction of travel of the installer.

Preferably the tool can be caused to move laterally to the direction of travel of the installer by the robot.

Preferably the arm can be caused to move laterally to the direction of travel of the installer to allow product to be held at the end of the arm more proximate and more distal the base.

Preferably the arm can be caused to move laterally to the direction of travel of the installer by the robot to allow product to be held at the end of the arm more proximate and more distal the base

Preferably the arm can be caused to move laterally to the direction of travel of the installer to allow product to be held at the end of the arm and be positioned on a notional line of the array, independent of the proximity of the base relative to the notional line.

Preferably the arm can be caused to move laterally to the direction of travel of the installer to allow product from the store to be received by the tool and be positioned by the tool on a notional line of the array.

Preferably the arm can move a said tool engage to the arm to move more proximate the base and more distal the base.

Preferably the robot has a said arm that is able to extend and contract in length.

Preferably the robot is telescopic.

Preferably the robot can cause the tool to move in a vertical direction.

Preferably the robot can telescope to cause the tool to move in a vertical direction.

Preferably the arm and or the tool can apply a vertical force to the tool and to the product help by the tool.

Preferably the robot can apply a vertical pressure to a ground screw held by a tool engaged to the arm to help cause the ground screw to penetrate into the ground.

Preferably the robot can be moved to allow vertical pressure to be applied to a ground screw as it penetrates the ground.

Preferably the robot is not able to move independently of the base in a direction parallel the notional line of the array.

Preferably the arm can be caused to move laterally to the direction of travel of the installer to allow product from the store to be received by the tool and be positioned by the tool on a notional line of the array.

Preferably the arm can move a said tool engage to the arm to move more proximate the base and more distal the base.

Preferably the arm is able to extend and contract in length.

Preferably the arm is telescopic.

Preferably the arm can cause the tool to move in a vertical direction.

Preferably the arm can telescope to cause the tool to move in a vertical direction.

Preferably the arm and or the tool can apply a vertical force to the tool and to the product help by the tool.

Preferably the arm can apply a vertical pressure to a ground screw held by a tool engaged to the arm to help cause the ground screw to penetrate into the ground.

Preferably the arm can be moved to allow vertical pressure to be applied to a ground screw as it penetrates the ground.

Preferably the arm is not able to move independently of the base in a direction parallel the notional line of the array.

Preferably the arm is able to hinge relative to the base.

Preferably the arm is able to hinge relative to the base to be presented to extend substantially vertically.

Preferably the arm is able to hinge relative to the base to be presented to hold at least one of the ground screws and posts to extend substantially vertically.

Preferably the arm includes a first sensor.

Preferably the first sensor is a level sensor.

Preferably the level sensor communicates with an actuator that can control the hinge angle between the arm and the base.

Preferably the level sensor automatically communicates with an actuator that can automatically control the hinge angle between the arm and the base.

Preferably the level sensor communicates with an actuator that can control the hinge angle between the arm and the base to ensure the ground screw and/or post is positioned at an appropriate angle to the ground during the locating of the ground screw and/or post into the array.

Preferably the arm includes a second sensor.

Preferably the second sensor is a location sensor to help determine the position of the arm relative to a reference point or location.

Preferably the second sensor is a position location sensor.

Preferably the second sensor is a global position location sensor.

Preferably the second sensor is global navigation satellite sensor.

Preferably the second sensor communicates with an actuator that can control the position between the arm and the base.

Preferably the second sensor automatically communicates with an actuator that can automatically control the position between the arm and the base.

Preferably the second sensor communicates with an actuator that can control the position between the arm and the base to ensure the ground screw and/or post is positioned at an appropriate location to the ground during the locating of the ground screw and/or post into the array.

Preferably the tool is able to move relative to said arm.

Preferably the tool is able to be controlled for movement relative to said arm.

Preferably the tool can rotate about at least one axis relative said arm.

Preferably the tool can rotate about at least two axes relative said arm.

Preferably the arm is able to move

Preferably two arms, each able to receive a or each tool type.

Preferably the containerised store houses its respective plurality of product inside a container.

Preferably the container can be loaded and unloaded to and from the product supporter.

Preferably the container can be

Preferably the installer or installation system includes at least one of the stores of a plurality of product comprising of one of each of ground screws, posts and barrier strap.

Preferably a ground screw or ground anchor is secured to or integrally formed with a post.

Preferably a said ground screw or ground anchor and a said post are provided as an integrally formed or assembled unit.

Preferably the road barrier installer is an automated road barrier installer.

Preferably the road barrier installer can erect at least a 200 m array every hour.

Preferably the road barrier installer can erect at least a 300 m array every hour.

Preferably the road barrier installer can erect at least a 400 m array every hour.

In a further aspect the present invention may be said to be a road safety barrier installation system for installing an array of ground penetrating anchor supported spaced apart posts that in concert support at least one barrier strap that extends along the array, the road safety barrier installer comprises:
a) a work station, able to be guided for movement along the road adjacent to the location of the array,
b) at least one product supporter able to be guided for movement along the road adjacent to the location of the array, preferably coupled to or integrally formed or connected with the work station,
   A. wherein the product supporter is adapted to receive one of (i) a single store of a plurality of product comprising of a plurality of ground penetrating anchor, posts and barrier strap and (ii) a plurality of stores, individually, of a plurality of product comprising of one of each of ground penetrating anchor, posts and barrier strap, and
   B. wherein the work station comprises at least one placement robot able robot able to
      i. receive and hold a said product, and
      ii. position the so received and held product in location as part of the array.

In a further aspect the present invention may be said to be a multi-function road safety barrier installer for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array, wherein the product supporter is adapted for receipt of:
   i. a single store of product comprising at least two of: at least one ground screw, at least one post and/or at least one barrier strap, the at least one placement robot being thus adapted to receive from said single store of product, and position and install in location as part of the array, any of said at least one ground screw, at least one post and/or at least one barrier strap, or
   ii. a store of product of a plurality of stores of product each comprising either: at least one ground screw, at least one post or at least one barrier strap, the product supporter configured to change a so-received store of product of the plurality of stores of product with another store of product of the plurality of stores of product, the at least one placement robot being thus adapted to receive from a so-received store of product, and position and install in location as part of the array, any of said at least one ground screw, at least one post and/or at least one barrier strap.

In a further aspect the present invention may be said to be a multi-function road safety barrier installer for installing a road-safety barrier comprising an array of ground screw supported spaced apart posts that in concert support at least one flexible elongate barrier strap that is tensioned to extend along said array of spaced apart posts when installed, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array, wherein the product supporter is adapted to receive one of:
   i. a single store of a plurality of product comprising of at least two of: at least one ground screw, at least one post and/or at least one barrier strap, and
   ii. a plurality of stores, each individually comprising of a plurality of product comprising of one of: at least one ground screw, at least one post or at least one barrier strap, and
wherein the installer is configured to be switchable to and from: a ground screw installation configuration, a post installation configuration and/or a barrier strap installation configuration, such that the at least one placement robot is adaptable to receive, position, and/or install any of said at least one ground screw, at least one post and/or at least one barrier strap, in location as part of the barrier being or to-be installed.

In a further aspect the present invention may be said to be a multi-function road safety barrier installer for installing a road-safety barrier comprising an array of ground screw supported spaced apart posts that in concert support at least one flexible elongate barrier strap that is tensioned to extend along said array of spaced apart posts when installed, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array, wherein the product supporter is adapted to receive a single store of a plurality of product comprising of at least two of: at least one ground screw, at least one post and/or at least one barrier strap,
wherein the installer is configured to be switchable to and from: a ground screw installation configuration, a post installation configuration and/or a barrier strap installation configuration, such that the at least one placement robot is adaptable to receive, position, and/or install any of said at least one ground screw, at least one post and/or at least one barrier strap, in location as part of the barrier being or to-be installed.

In a further aspect the present invention may be said to be a multi-function road safety barrier installer for installing a road-safety barrier comprising an array of ground screw supported spaced apart posts that in concert support at least one flexible elongate barrier strap that is tensioned to extend along said array of spaced apart posts when installed, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array, wherein the product supporter is adapted to receive and/or switch between a plurality of stores, each individually comprising of a plurality of product comprising of one of: at least one ground screw, at least one post or at least one barrier strap,
wherein the installer is configured to be switchable to and from:
   i. a ground screw installation configuration,
   ii. a post installation configuration, and/or
   iii. a barrier strap installation configuration,
such that the at least one placement robot is adaptable to receive, position, and/or install any of said at least one ground screw, at least one post and/or at least one barrier strap, in location as part of the barrier being or to-be installed.

In a further aspect the present invention may be said to be a multi-function road safety barrier installer for installing a road-safety barrier comprising an array of ground screw supported spaced apart posts that in concert support at least one flexible elongate barrier strap that is tensioned to extend along said array of spaced apart posts when installed, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array, wherein the product supporter is adapted to receive a single store of a plurality of product comprising of at least two of: at least one ground screw, at least one post and/or at least one barrier strap,
wherein the installer is configured to be switchable to and from:
   i. a ground screw installation configuration, in which the work station is configured to convey at least one ground screw from said store to said placement robot
   ii. a post installation configuration, in which the work station is configured to convey at least one post from said store to said placement robot and/or
   iii. a barrier strap installation configuration in which the work station is configured to convey at least one ground screw from said store to said placement robot,
such that the at least one placement robot is adaptable to position, and/or install any of said at least one ground screw, at least one post and/or at least one barrier strap, in location as part of the barrier being or to-be installed.

In a further aspect the present invention may be said to be a multi-function road safety barrier installer for installing a road-safety barrier comprising an array of ground screw supported spaced apart posts that in concert support at least one flexible elongate barrier strap that is tensioned to extend along said array of spaced apart posts when installed, the road safety barrier installer comprising:
a. a prime mover able to travel along a road adjacent to an installation location of the road-safety barrier being or to-be installed,
b. a work station, towed by or part of or otherwise able to move with and by the prime mover, along the road adjacent to the installation location, wherein the work station comprises a base, towed by or part of or otherwise able to move with and by the prime mover, and at least one placement robot able move relative to the base,
c. a product supporter, towed by or part of or otherwise able to move with and by the prime mover and/or the work station, along the road adjacent to the location of the array,
wherein the product supporter is adapted to receive a store of a plurality of product comprising any one or more of: at least one ground screw, at least one post and/or at least one barrier strap, and
wherein the work station comprises and is adapted to select and switch between: at least one ground screw tool, at least one post tool and/or at least one barrier strap tool,
the product supporter and work station thereby being together adaptable to switch to and from: a ground screw installation configuration, a post installation configuration and/or a barrier strap installation configuration, for positioning and/or installation of any of said at least one ground screw, at least one post and/or at least one barrier strap, in location as part of the barrier being or to-be installed.

In a further aspect the present invention may be said to be a road safety barrier installer for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array r, the road safety barrier installer comprising:
a. a prime mover able to travel along a road adjacent to the location of the array,
b. a work station, towed by or part of or otherwise able to move with and by the prime mover, along the road adjacent to the location of the array, the work station comprising at least one robot, and
c. a product supporter, towed by or part of or otherwise able to move with and by the prime mover and/or the work station, along the road adjacent to the location of the array, the product supporter configured to be able to receive a store of product comprising:
   i. a store of a plurality of ground screws,
   ii. a store of a plurality of posts,
   iii. a store of at least one barrier strap, and/or
   iv. a store of a plurality of ground screws, a plurality of posts and at least one barrier strap,
the at least one robot being adaptable to select, position and install, in location as part of the array, a plurality of ground screws, a plurality of posts and/or at least one barrier strap, wherein said selection is defined by the store of product received by said product supporter.

In a further aspect the present invention may be said to be a road safety barrier installation system for installing for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array, the road safety barrier installation system comprising:
a. a prime mover able to travel along a road adjacent to the location of the array,
b. a work station, towed by or part of or otherwise able to move with and by the prime mover, along the road adjacent to the location of the array, the work station comprising at least one robot, and
c. a product supporter, towed by or part of or otherwise able to move with and by the prime mover and/or the work station, along the road adjacent to the location of the array, the product supporter adapted to receive a store of product selected from, and changeable with any one of, a plurality of stores of product,
d. the at least one robot being adaptable to position and install, in location as part of the array, at least one product received from said store of product, the system being configured for sequential installation of:
   i. at least one first product received from a first store of product of the plurality of stores of product, prior to changing said first store of product to a second store of product of the plurality of stores of product, and
   ii. installing at least one second product received from said second store of product of the plurality of stores of product, prior to changing said second store of product to a third store of product of the plurality of stores of product, and
   iii. installing at least one third product received from said third store of product of the plurality of stores of product.

In a further aspect the present invention may be said to be a road safety barrier installation system for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array, the road safety barrier installation system comprising a plurality of installers each comprising:
a. a prime mover able to travel along a road adjacent to the location of the array, and
b. a product supporter, towed by or part of or otherwise able to move with and by the prime mover, along the road adjacent to the location of the array,
wherein each product supporter of each installer comprises a store of product the contents of which comprise any one or more of: a plurality of ground screws, a plurality of posts and/or at least one barrier strap, the plurality of installers together configured for sequential installation of the array by way of a procession of the plurality of installers along the road, wherein a position of each installer relative the other installer(s) within the procession is defined at least in part by the contents of the store of product carried by each installer.

In a further aspect the present invention may be said to be a road safety barrier installation system for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array, the road safety barrier installation system comprising a first, second and third installer each comprising:
a. a prime mover able to travel along a road adjacent to the location of the array,
b. a work station, towed by or part of or otherwise able to move with and by the prime mover, along the road adjacent to the location of the array, said work station comprising at least one placement robot, and
c. a product supporter, towed by or part of or otherwise able to move with and by the prime mover and/or work station, along the road adjacent to the location of the array,
wherein the product supporter of the first installer comprises a plurality of ground screws, the product supporter of the second installer comprises a plurality of posts, and the product supporter of the third installer comprises at least one barrier strap, the installers together configured for sequential installation of the array by way of a procession of the plurality of installers along the road, wherein positioned:
   i. at a lead position of said procession is the first installer, its at least one placement robot configured for positioning and installation of the plurality of ground screws,
   ii. at an intermediate position of said procession is the second installer, its at least one placement robot configured for positioning and installation of the plurality of posts to the installed ground screws, and
   iii. at a trailing position of said procession is the third installer, its at least one placement robot configured for positioning and installation of the at least one barrier strap to the installed posts.

In a further aspect the present invention may be said to be a method for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array parallel to the road to define at least part of a road safety barrier, the method comprising:
a. together guiding: (i) a product supporter and (ii) at least one placement robot, along the road adjacent to the location of the array in a sequence of passes, wherein:
   i. in a first pass along the road, the product supporter comprises a plurality of ground screws and the at least one placement robot is adapted for positioning and installation of the plurality of ground screws during said first pass,
   ii. in a second pass along the road in the same or opposite direction as the first pass, the product supporter comprises a plurality of posts and the at least one placement robot is adapted for positioning and installation of the plurality of posts to the installed plurality of ground screws, during said second pass, and
   iii. in a third pass along the road in the same or opposite direction as the first and/or second pass, the product supporter comprises at least one barrier strap and the at least one placement robot is adapted for positioning and installation of the at least one barrier strap to the installed plurality of posts, during said third pass.

Preferably, the at least one barrier strap comprises an elongate tensioned flexible strap comprising a planar face facing the road in use when installed as part of said array.

Preferably, each of the ground screw supported spaced apart posts and/or portion(s) thereof are configured, when installed as part of the array, to each support the at least one strap and to release from the strap during or after impact from an errant vehicle and/or rider.

Preferably, the at least one barrier strap comprises an elongate tensioned flexible strap comprising a planar face facing the road in use when installed as part of said array.

Preferably, each of the ground screw supported spaced apart posts and/or portion(s) thereof are configured, when installed as part of the array, to each support the at least one strap and to release from the strap during or after impact from an errant vehicle and/or rider.

Preferably, the at least one flexible elongate barrier strap is relatively flexible and pliable, and/or has a low stiffness once installed.

Preferably, the at least one flexible elongate barrier strap is tensioned to between 200 kN and 400 kN once installed.

Preferably, the at least one flexible elongate barrier strap is configured such that its planar face comprises a surface that is relatively smooth, and/or continuous along the length of the strap.

Preferably, the at least one flexible elongate barrier strap comprises a yield strength greater than 450 MPa.

Preferably, the at least one flexible elongate barrier strap comprises a yield strength of 530 MPa. Other aspects of the invention may become apparent from the following description which is given by way of example only and with reference to the accompanying drawings.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purposes of this specification, the term “plastic” shall be construed to mean a general term for a wide range of synthetic or semisynthetic polymerization products, and generally consisting of a hydrocarbon-based polymer.

For the purpose of this specification, where method steps are described in sequence, the sequence does not necessarily mean that the steps are to be chronologically ordered in that sequence, unless there is no other logical manner of interpreting the sequence.

The term “along the road” or “along a road” as used herein means on the road or adjacent to the road or its carriage way for example.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

The invention will now be described by way of example only and with reference to the drawings in which:

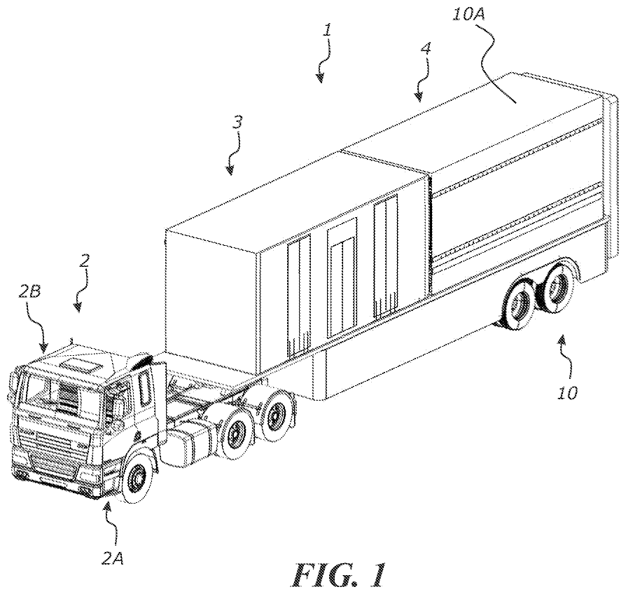

FIG. 1: is a perspective view of a safety barrier installer of the present invention in a first configuration;

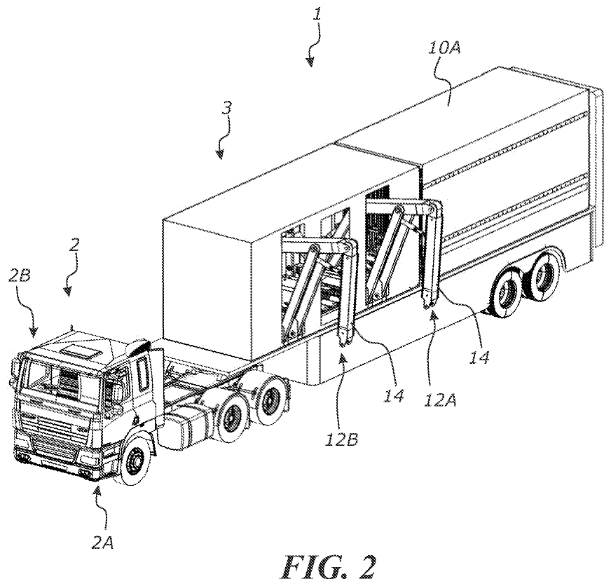

FIG. 2: is a perspective view of the barrier installer of FIG. 1 in a second configuration;

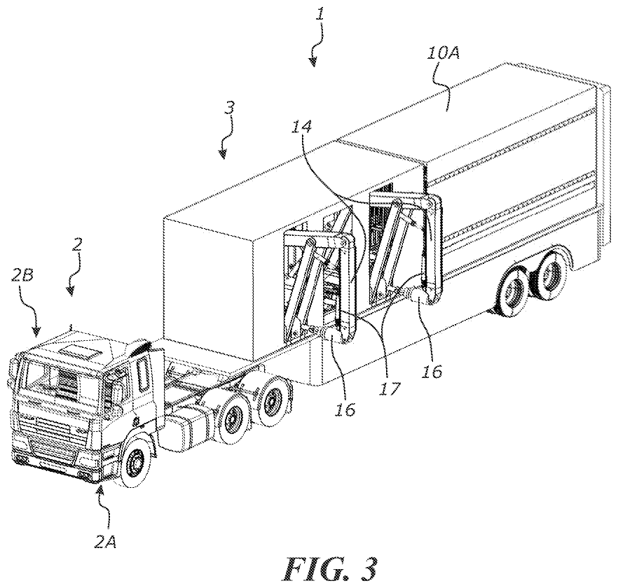

FIG. 3: is a perspective view of the barrier installer of FIG. 1 in a further configuration;

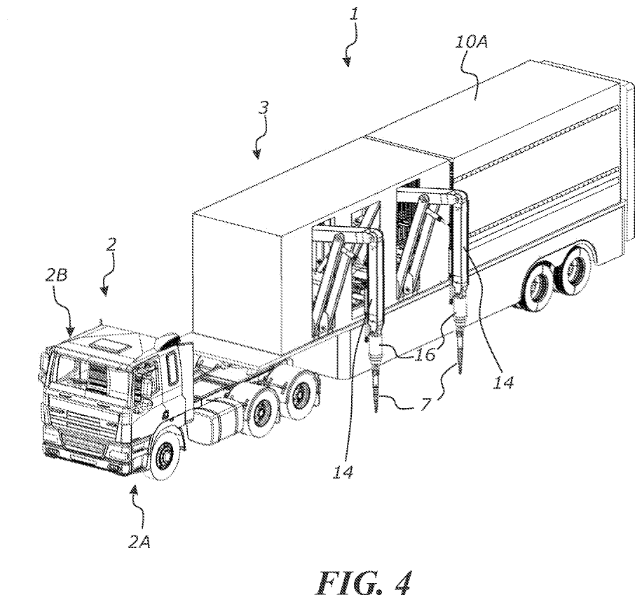

FIG. 4: is a perspective view of a barrier installer of the present invention in a further configuration;

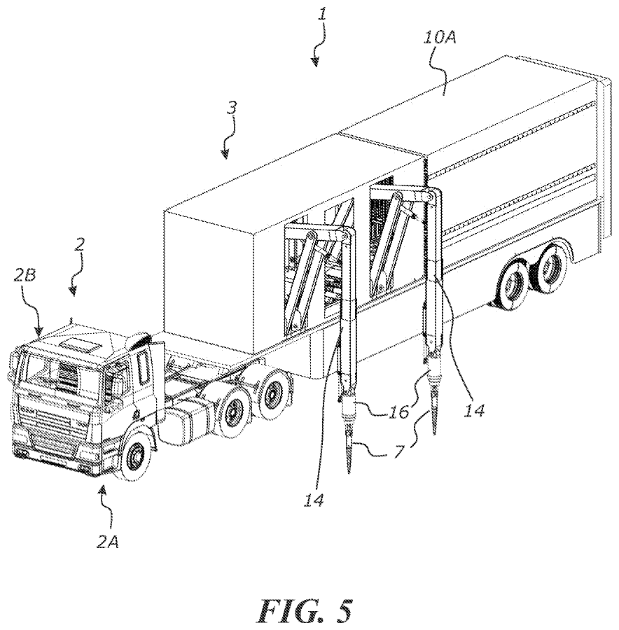

FIG. 5: is a perspective view of the barrier installer of FIG. 1 in a further configuration;

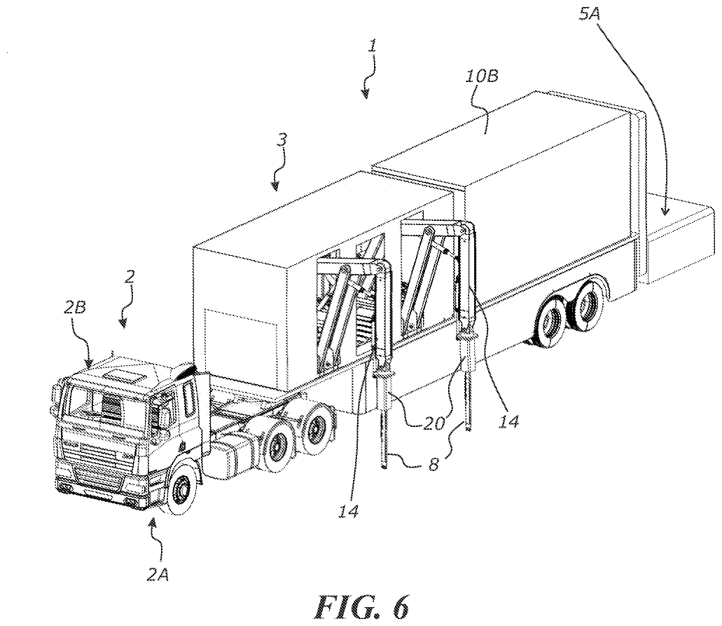

FIG. 6: is a perspective view of the barrier installer of FIG. 1 in a further configuration;

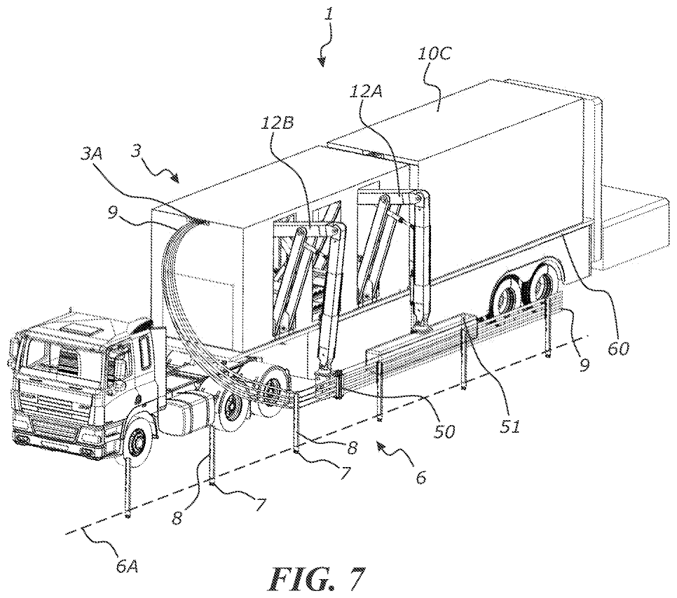

FIG. 7: is a perspective view of a barrier installer of the present invention in a further configuration;

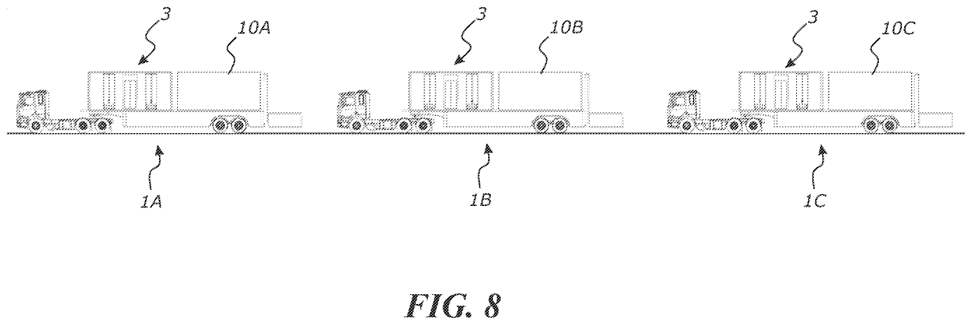

FIG. 8: illustrates a barrier installation system of the present invention utilising three prime movers each performing an operation separate from each other in the installation of the barrier;

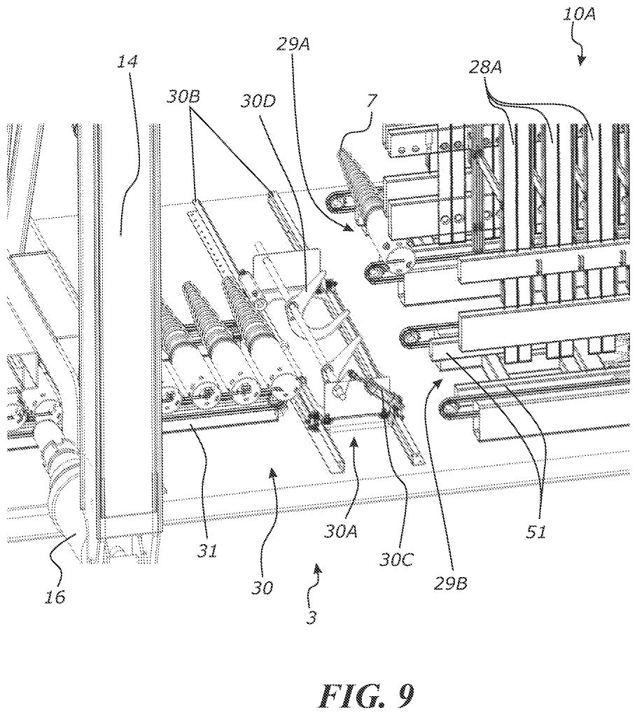

FIG. 9: is a close up perspective view of part of the work station and product support;

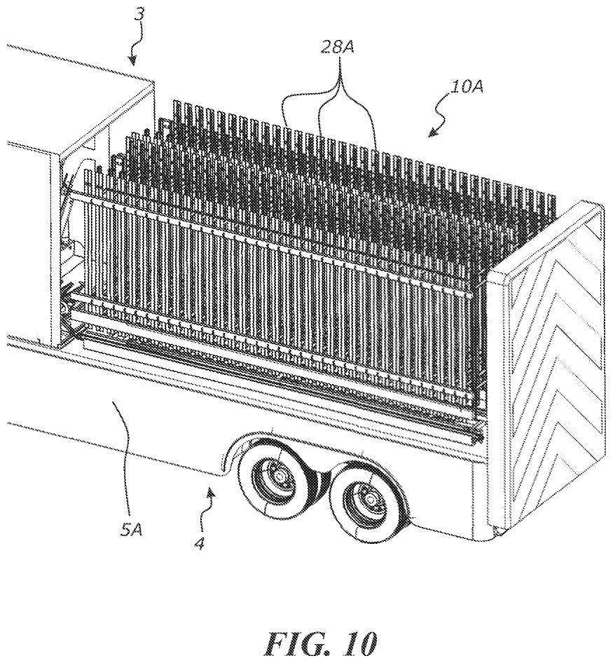

FIG. 10: illustrates magazines of the store of ground screw anchors;

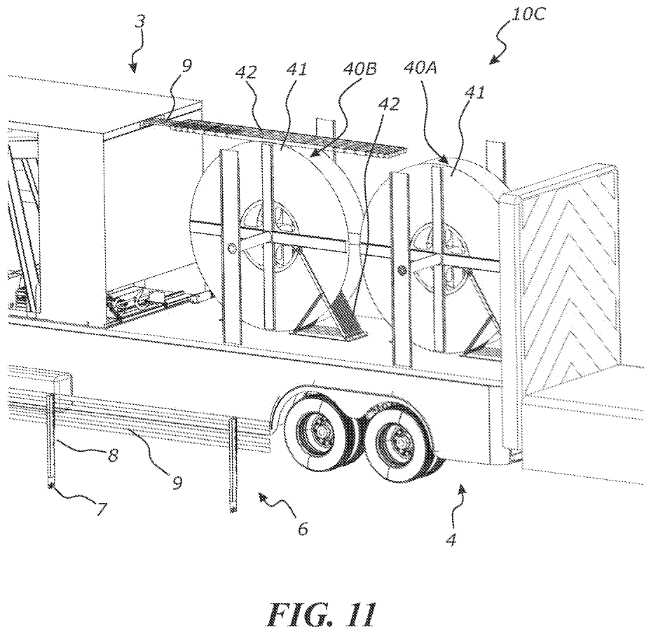

FIG. 11: is a perspective view showing a store of barrier strap;

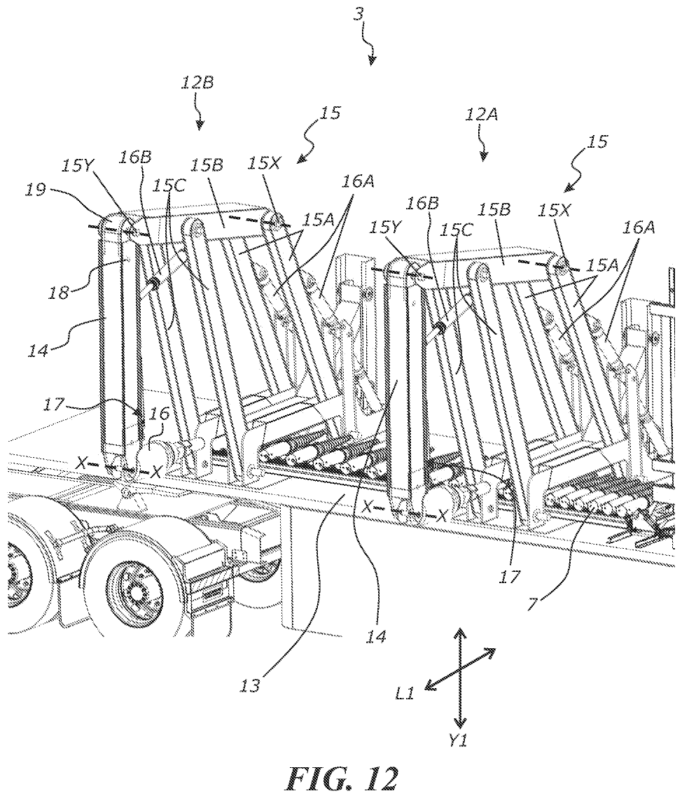

FIG. 12: is a close up view of the work station showing two robots;

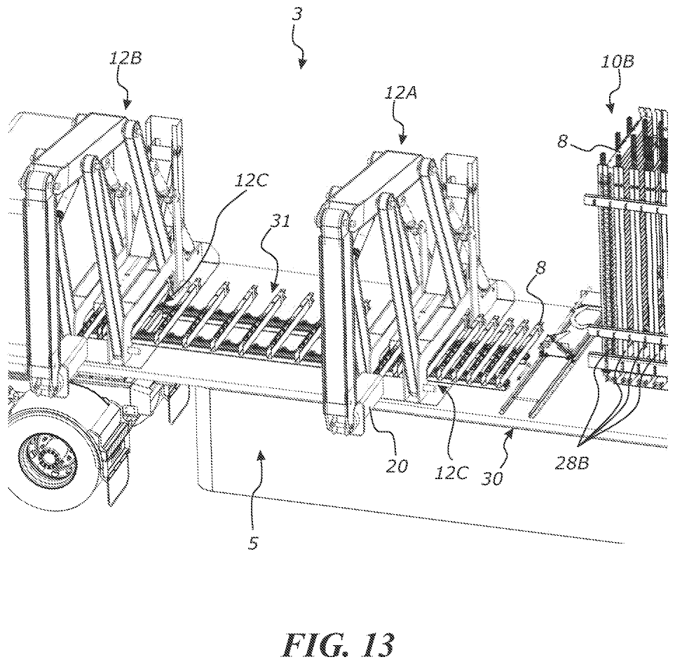

FIG. 13: is an alternative view of FIG. 13;

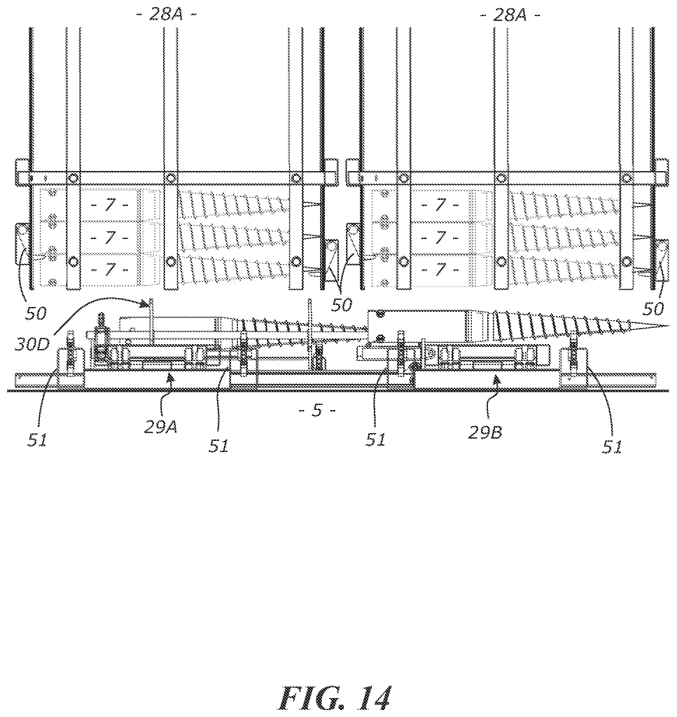

FIG. 14: Is a close up view of the anchor store;

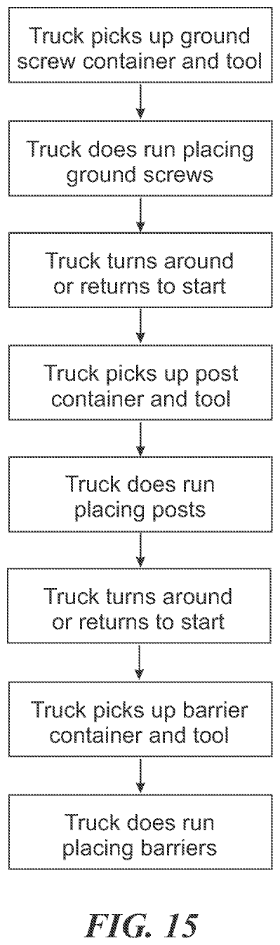

FIG. 15: shows a flow diagram of a process of the present invention;

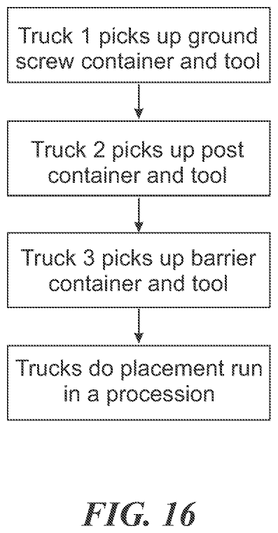

FIG. 16: shows an alternative flow diagram of an alternative process of the present invention.

### DETAILED DESCRIPTION

The present invention relates to a road safety barrier installer, systems of use of said road safety barrier installer and embodiments thereof, as well as associated methods for road safety barrier installation.

In some embodiments, the invention is an automated safety barrier installer that automates at least in part, the process of installing a road safety barrier adjacent to, for example, a carriage way of a road.

The safety barrier installer may provide, act or be adapted or configured to act in a multi-function, autonomous and independent capacity, in that it may be employed in erecting at least part of a length of a road safety barrier or array thereof, without the need for auxiliary equipment/vehicles and/or personnel.

In particular, installer(s), system(s), and method(s) described herein may reduce the need for road-side personnel, and thus drastically reduce the risk of injury or accidents typical with road-side safety barrier installation on public roads still in use during installation.

Moreover, the installer(s), system(s), and method(s) described herein may, in part due to their multi-function and independent capacity, comprise a self-contained and modular arrangement as will herein be described, that allows for ease of use on public roads, and ease of relocation and/or movement/handling with standard equipment.

Generally, a road safety barrier installer of the present invention may comprise of a work station 3 and a product supporter 4. It may also comprise of a prime mover 2.

An example or embodiment installer 1 is seen in FIG. 1. As seen in the embodiment in FIG. 1, the prime mover 2 may comprise of a truck 2A and a trailer or trailer unit 5.

The trailer 5 is preferably able to be towed by the truck 2A and be thereby controlled for speed and direction of movement.

It may be noted that the trailer 5 may be provided with a rearward facing/mounted impact-attenuator 5A (shown deployed in FIG. 6) which can absorb the impact of an errant 2 to 3 ton vehicle approaching from the rear at about 100 kilometres per hour. The weight of the trailer 1 including said work station 3 and product supporter 4 may be about 20 tons, when at full capacity, which may provide further resilience against impact.

Moreover if the prime mover 2 takes the form of a truck 2A, said truck will preferably comprise a cab 2B as shown in FIG. 1 that is elevated at least about 1.5 meters above the ground surface, such that if any operator(s) occupy said cab 2B, they will at least be positioned above where an errant vehicle may impact the truck 2A from the forward direction.

Thus, the safety barrier installer described herein may be adapted for maximum safety against impact from errant vehicles during installation and may also maximise the safety of any operator(s) present in the cab 2B of the truck 2A during a forward impact.

In some embodiments, the road safety barrier installer is capable of installing an array 6 of ground screw supported spaced apart posts 8 that in concert support at least one barrier strap 9 that extends along the array.

These components can, for example, be seen in FIG. 7 where in an array formation 6, a plurality of ground screws or ground screw anchors 7 are installed (positioned and depressed into the ground and therefore hidden from view in FIG. 7), each having a post 8 projecting upwardly therefrom and presented to receive at least one barrier strap 9 which spans between each post 8 of the array 6 and along the array.

In a preferred form, an embodiment road-safety barrier installed or provided for installation by the road safety barrier installer 1 described herein comprises an array of ground screw supported spaced apart posts 8 that in concert support at least one flexible elongate barrier strap 9 that is tensioned to extend along said array 6 of spaced apart posts 8, when installed.

The at least one flexible elongate barrier strap 9 may comprise a planar face facing the road in use when installed as part of said array 6. Such a tensioned flexible elongate strap arrangement may in some embodiments, be relatively flexible and pliable, and/or have a low stiffness once installed, be tensioned to between 200 kN and 400 kN once installed, and be configured such that its planar face comprises a surface that is relatively smooth, and/or continuous along the length of the strap.

Moreover, the partially complete barrier shown in, for instance, FIG. 7, comprises of four of said flexible elongate barrier strap(s) 9 that act together to provide resilient deflective behaviour during impact from an errant vehicle and/or rider.

In some embodiments the strap(s) 9 are composed of metal, such as high-strength ductile steel with a high yield strength greater than 450 MPa. In some embodiments, the strap(s) 9 are composed of 450 grade steel, with a 530 MPa yield, and elongation of 15% after yield.

In some embodiments each of the ground screw supported spaced apart posts 8 and/or portion(s) thereof are configured, when installed as part of the array 6, to each support the at least one strap 9 and to release from the at least one strap 9 during or after impact from an errant vehicle and/or rider.

In some embodiments, the at least one flexible elongate barrier strap 9, the posts 8, the ground screws 7 and/or the embodiment road-safety barrier(s) described herein may be configured as described in WO/2021/070122A1, the contents of which are incorporated herein by reference in their entirety.

It should be noted that when the term “array” is used herein, it may generally refer to the plurality of ground screws 7 (and/or posts 8 secured thereto) that extend along side/parallel a road, and define at least part of a road-safety barrier. “Array” may therefore refer to a notional to-be-installed array (of screws 7 and/or posts 8), a partially complete array 6 as can be seen in FIG. 7, where a plurality of ground screws 7 are already depressed/installed with respective posts 8 secured thereto, and/or a fully installed array (i.e., a plurality of ground screws 7 and posts 8 extending along an entire continuous or discrete length of a road-safety barrier).

Additionally, or alternatively, it may also refer to the notional installation location(s) or positions at which said ground screw anchor(s) 7 and/or post(s) 8 are being, or are to be, installed as part of a road-safety barrier, i.e., a notional installation location or location(s) of the road-safety barrier being or to-be installed. This can for instance be seen in FIG. 7 where the dashed line 6A indicates a notional array-installation “path” or “foot-print”.

An array 6 or barrier being installed may be of any length desired, with the installer described herein in some instances being employed for erection of a notionally endless barrier and/or discrete lengths thereof.

Those skilled in the art will appreciate that an example road safety barrier may comprise of said array, one or more barrier straps, as well as any other auxiliary items/features (such as tensioning elements for the straps, end-anchor's and the like) know in the art.

As can be seen in FIG. 7, four substantially parallel flexible elongate barrier straps 9 are supported as part of the array 6. At terminal ends of the array (not shown), there may be provided a foundation or block or other ground engaged member for anchoring the straps directly or indirectly and to help tension the barrier strap between the terminal ends and across/along the array 6.

The array 6 that is capable of being installed at least in part by the road safety barrier installer 1 of the present invention, is preferably located adjacent to a carriage way of a road. The term “road” may include a highway or motorway, lane, street or other similar installation along which vehicles are able to travel.

In a preferred form the road safety barrier installer 1 is able to travel along the road adjacent to the location of the array 6 as seen for example in FIG. 7. The road safety barrier installer may move along the carriage way side of the array or the opposite side of the array to the carriage way. In some instances, the road safety barrier may be installed by the installer of the present invention, as a median barrier splitting a carriage way in two, to create a dual carriage way.

In a preferred form, the posts 8 are secured relative to the ground by a ground screw anchor 7. However, it is envisaged that other devices can be used and therefore the post may be supported by ground anchors (some of which may not be screwed into the ground, but may in an alternative form be vibrated into the ground as an example). The use of ground screws is convenient and helps ensure a strong and stable connection is made with the ground to support the posts 8.

As will herein be described, the road safety barrier installer may automate at least in part, the installation of the road safety barrier to provide a fast and accurate process for installing a road safety barrier. The speed of operation reduces disruption to road users and may also reduce accidents during installation, given that the process is, at least in part, automated thereby protecting installation operators from injury during the installation process. Installation may indeed include situations where the carriage way is in use by other road workers and/or the general public.

The road safety barrier installer is capable of installing, in a single pass along the road, one or more or each of the following:
(i) a plurality of ground screw anchors 7 to be positioned and installed along the road,
(ii) posts 8 to be secured to the installed ground screw anchors 7, and
(iii) a barrier strap or straps 9 to be engaged to each installed post 8 and extending along the array 6 of screws 7 and posts 8.

As will be appreciated, in some embodiments of the invention the prime mover 2 may form part of the invention or may be an ancillary component yet still to be used with the invention for causing the invention to move along the array.

Common to the receipt, positioning and installation of all of the above three products or components (i) (ii), (iii) is the work station 3, described in further detail below.

In some embodiments, the product supporter 4 described above, towed by or part of or otherwise able to move with and by the prime mover 2 and/or the work station 3, along the road adjacent to the location of the array, is adapted to receive one or more stores 10, that in some embodiments are specific for each of the three products or components (i), (ii), (iii) described above, and in other embodiments, may house two or more of the three products described above.

The store or stores 10, in a preferred form, may take the form of a first store 10A (comprising a store of ground screw(s) 7), a second store 10B (comprising a store of post(s) 8) and/or a third store 10C (comprising a store of barrier strap(s) 9). Each of these embodiment stores 10A, 10B, 10C may each individually and interchangeably be placed at/on/within the product supporter 4.

In some embodiments, each of the stores 10A, 10B, 10C may be described as containerised stores, respectively of each of product(s) (i), (ii) and (iii) described above.

In some embodiments, said stores 10A, 10B, 10C may be configured to the same size and dimensional specifications as a standard shipping container, i.e. a 20-ft high cube shipping container, to allow for easy adaption and handling by standard lifting equipment, such as a conventional swing lift container transporter.

Further, the work station 3 and product supporter 4, and the trailer 5 of the truck 2A, when so provided as part of an embodiment installer, may each be configured to the same size and dimensional specifications as a standard heavy-duty, multi-wheel truck trailer, such that the installer 1 may more easily adapt to standard roads/carriageways and their widths etc designed to accommodate a standard truck trailer.

It will be appreciated that a standard heavy-duty, multi-wheel truck trailer may be configured to accommodate said dimensional specifications as a standard shipping container. In this manner, everything rear of the prime mover of a given embodiment installer may be defined by standardised dimensional specifications known in the art, and thus able to be accommodated for easily by standard logistical equipment and personnel on typical public roads/carriageways alike.

For instance, a store of posts 10B may take the form of a standard 20 ft high cube shipping container and include approximately three or four kilometres worth of posts 8.

In some embodiments however, the work station 3, product supporter 4, trailer 5 and/or stores 10A, 10B, 10C may be otherwise configured with customised dimensions different to typical standards known in the art.

The containerised store(s) 10A, 10B, 10C is/are able to be placed on and removed from the product supporter 4 as and when required for the specific operation of the barrier installer 1 of the present invention i.e. depending on which of the product(s) (i), (ii), (iii) outlined above are due for positioning and/or installation.

In this manner, the installer 1 may be described as multi-functional and modular, in that it may be adapted for installation of all of the products (i), (ii), (iii) above, in part due to the interchangeability of said store(s) 10A, 10B, 10C.

For example, in a first pass of the array 6 the barrier installer 1 may carry upon or within the product supporter 4 thereof a store of ground screw anchors 10A or a ground screw container 10A. The array of ground screw anchors 7 are, in a first pass along the array 6, installed into the ground.

Ahead of a second pass of the array, the store of ground screw anchors 10A may then be removed from the product supporter 4 and replaced by a store of posts 10B or a post container 10B. The store of posts 10B is preferably also containerised and allows for a plurality of posts 8 to be loaded upon or within the product supporter 4.

The installer is then moved along the array in a second pass to position and secure a post 8 to each of the previously installed ground screw anchors 7.

At the completion of the second pass, the post container 10B is able to be removed from the product supporter 4 and is able to be replaced by a store of barrier straps 10C or barrier strap store 10C. The installer is then moved along the array in a third pass to secure the barrier strap or straps 9 to the previously installed posts 8. In some embodiments, the installer 1 may install the straps 9 in a tensioned manner across the posts 8 such that the partially or fully completed/installed barrier presents at least one tensioned elongate strap 9 as described above.

In this example, common to each of the passes is the work station 3. In a preferred form, common to this mode of operation is the prime mover 2 such as a truck 2A. Hence the truck 2A and the trailer 5 carrying the work station in this preferred form remain common for each of the three passes.

Therefore, what may be described as the substitutable or interchangeable component of the installer 1 is the store 10 comprising either a store of a plurality of ground screw anchors 10A, a store of a plurality of posts 10B and/or a store of the barrier strap or straps 10C.

In some embodiments, the store 10 so supported by the product supporter 4 may comprise multiple types of products, rather than only one. As such, some configurations of the installer 1 may be adapted to carry two or all three of: at least one ground screw 7, at least one post 8 and/or at least one barrier strap 9. In such a configuration, a single installer 1 may be provisioned for positioning and installation of all three of these components about a certain length or distance of a road-safety barrier.

Those skilled in the art will therefore appreciate that said embodiments of the road safety barrier installer 1 described herein, by provision of this advantageous multi-product capability, may be configured and adapted for the positioning and installation of any one or more, or all of, the ground screws/anchors 7, the posts 8 and the flexible elongate barrier straps 9 of the road-safety barrier(s) described herein, once more without the need for additional auxiliary machinery, apparatus and/or workers/personnel and the extensive down-time associated with the provision and preparation of such.

Moreover, this multi-product capability or multi-function capability may be defined by the installer being configured to be switchable to and from: a ground screw installation condition or configuration, a post installation condition or configuration and/or a barrier strap installation condition or configuration such that the installer is adaptable to receive, position, and/or install any of said at least one ground screw, at least one post and/or at least one barrier strap, in location as part of the barrier being or to-be installed.

A ground screw installation condition or configuration may comprise of the installer being adapted or configured for receipt, handling, positioning and/or installation of one or more ground screw(s) 7.

In particular, the ground screw installation condition or configuration may comprise the robot(s) being connected to and utilising anchor driving tool(s) 16 at the distal end(s) of the arm(s) 14 thereof (as will be described in further detail below) for said receipt, handling, positioning and/or installation of at least one or more ground screw(s) 7, with the product supporter 4 comprising a store of product comprising at least one or more ground screw(s) 7, whether that be a store of ground screws 10C only, or a containerised store 10 having a plurality of different product including said at least one or more ground screw(s) 7.

A post installation condition or configuration may comprise of the installer being adapted or configured for receipt, handling, positioning and/or installation of one or more post(s) 8.

In particular, the post installation condition or configuration may comprise the robot(s) being connected to and utilising post connection tool(s) 20 at the distal end(s) of the arm(s) 14 thereof (as will be described in further detail below) for said receipt, handling, positioning and/or installation of one or more post(s) 8, with the product supporter 4 comprising a store of product comprising at least one or more post(s) 8, whether that be a store of posts 10B only, or a containerised store 10 having a plurality of different product including said at least one or more post(s) 8.

A barrier strap installation condition or configuration may comprise of the installer being adapted or configured for receipt, handling, positioning and/or installation of one or more strap(s) 9.

In particular, the barrier strap installation condition or configuration may comprise the robot(s) being connected to and utilising strap guide tool(s) 50 and/or strap fastener tool(s) 51 at the distal end(s) of the arm(s) 14 thereof (as will be described in further detail below) for said receipt, handling, positioning and/or installation of one or more strap(s) 9, with the product supporter 4 comprising a store of product comprising at least one or more strap(s) 9, whether that be a store of straps 10C only, or a containerised store 10 having a plurality of different product including said at least one or more strap(s) 9.

By this manner, one will appreciate that the example safety barrier installation system described above utilising a single/the same installer 1, may comprise a first pass with the installer configured in a ground screw installation condition or configuration, the second pass with the same installer configured in a post installation condition or configuration, and a third pass with said installer configured in a barrier strap installation condition or configuration.

In an alternative mode of operation as illustrated for example in FIG. 8 and shown in flow-chart form in FIG. 16, three barrier installers may be utilised—mainly 1A, 1B and 1C In this configuration the barrier installation system comprises of three prime movers (truck 1, truck 2 and truck 3, in FIG. 16), each having a work station and each carrying a respective product store 10A, 10B, 10C each comprising a different plurality of the products.

The lead installer 1A may therefore for instance be adapted for installing the ground screw anchors 7, the intermediate installer 1B adapted for installing the posts 8 to the ground screw anchors 7 and the trailing installer adapted for installing barrier strap or straps 9 to the posts 8, sequentially in that order. This is an alternative mode of operating the barrier installation system of the present invention. Each of the installers 1A, 1B, 1C may then in procession carry out their respective task of installing their respective product, where installer 1A is in a ground screw installation condition or configuration, installer 1B is in a post installation condition or configuration and installer 1C is in a barrier strap installation condition or configuration.

In yet a further alternative configuration, a single prime mover may be utilised and may connect, for each pass, to two or more different trailers 5, each having a work station 3 and a specific store of product.

However, in a preferred form the road barrier installation system as seen in FIG. 1 comprises of a trailer 5 that has a common work station 3 for each pass and has a product supporter 4 that allows for a different containerised store to be supported for each pass with one prime mover 2 for moving and guiding the installer 1 in multiple passes along the array 6. These passes may be in the same or opposite directions, with an example order of events illustrated in FIG. 15.

Those skilled in the art may envisage other configurations or adaptations of a road barrier installation system incorporating combinations or modifications of the above described embodiment system(s). Moreover, such alternative configurations or adaptations may comprise corresponding alternate methods, or sequences, for installing the product(s) described herein.

In a preferred form, the truck 2A and trailer 5 are of an articulated kind i.e., such that the trailer 5 is removably and pivotably attached to the truck 2A. However, in alternative forms the truck 2A may carry the trailer in a non-articulated form and the truck 2A may be integrally part of the work station 3 and product supporter 4, rather than being couplable and/or de-couplable relative thereto. As will hence be appreciated, the work station 3 is preferably able to be towed by, or part of, or otherwise able to move with and by the prime mover 2 along the road adjacent to the location of the array 6.

In some embodiments, the installer 1 may be able to be steered during installation along the location at where the array 6 is to be positioned. This ensures that the installer 1 travels substantially parallel to the array. In a preferred form, the prime mover 2 is controlled for steering. The prime mover 2, in the preferred form being a truck 2A, may be controlled for steering by a drive motor that may be operated by a programmable control system receiving data from a Global Navigation Satellite System (GNSS) or a local positioning system or both. As an example, the Trimble™ auto pilot electric self-steering system may be utilised and may receive information via a GNSS antenna 11 about the location of the antenna and hence the truck 2A. The control system may be programmed to cause the truck 2A to follow a specific path along the array 6.

The prime mover 2 is preferably self-powered and may include a motor such as an internal combustion engine or electric motor(s) and capability of carrying fuel or batterie(s) to power such.

Given that the barrier installer is substantially automated, once activated for installing a road safety barrier, preferably minimal input is required by an operator residing in the cabin 2B. The operator may merely be there to supervise the installation process and be there to activate an emergency stop, should something unexpected occur, such as interference to the movement of the installer 1 along the array.

Those skilled in the art will appreciate that other embodiment prime movers may be adapted for use in towing or moving, steering and/or directing the installer 1 described herein, as well as various means of propelling said prime mover, and automating its guiding and steering means.

Moreover, alternate trailer 5 adaptations may be envisaged that allow for combined or separately towed/articulated movement of a plurality of work station(s) 3, product supporters 4 and the like, along a carriageway (for example, a single longer trailer having multiple work station(s) and/or product supporter(s)).

The work station 3 preferably comprises of at least one placement robot 12 as can be seen in more detail in FIG. 12. The robot 12 is preferably supported by a base 13 of the work station which may, for example, be the base of part of the trailer 5.

In some embodiments, there may be two robots 12A and 12B, as shown. Where there is a plurality of robots as part of the installer, each robot may be configured to perform the same operation such as, for example, is seen in FIG. 3 where both robots shown are configured for inserting ground screw anchors into the ground. In some embodiments, each robot may be configured for a different operation as seen in FIG. 7 where the first robot 12A is configured for securing a barrier strap 9 to the posts 8 and the second robot 12B is used for guiding the barrier strap 9 prior to its securing to the post 8.

It is envisaged that at least one robot is used, however two robots are used as seen in the accompanying figures. Alternatively, and in some embodiments, more than two robots may be used (not shown).

The (or each) robot is able to move relative to the base 13 and relative to the array for installing at least one and preferably each of the three products or components (i), (ii), (iii) as described above.

In some embodiments, each robot comprises of an arm 14 that is supported relative to the base 13 in an articulated manner such as by an articulation mechanism 15 that may, for example, be a parallelogram or “four-bar linkage” style mechanism with actuators 16A and 16B utilised to control the movement of the arm 14 relative to the base 13. In particular, it may be seen that a plurality of actuators 16A, 16B, 17 may be provided to facilitate movement of the articulation mechanism 15 of the robot 12 principally through a lateral axis L1 extending across a width of the installer (i.e. across a width of the work station 3/trailer 5) so as to provide laterally inward and outward movement of the arm 14 of the robot 12 relative the workstation i.e., across the horizontal plane.

These same actuators 16A, 16B, 17 may also inadvertently action a movement of the articulation mechanism 15 of the robot 12, by way of the four bar linkage configuration thereof, through a vertical axis Y1 extending through the height of the installer (i.e., extending vertically across a height of the work station 3/trailer 5) so as to provide vertical upward and downward movement of the arm 14 of the robot 12 relative the workstation i.e., across the horizontal plane.

From a viewing of FIG. 12, those skilled in the art will be able to readily understand how pivoting/movement of primary link(s) 15A, intermediate link(s) 15B and secondary link(s) 15C of the four-bar linkage style articulation mechanism 15 by action of the actuators 16A, 16B, 17 thereof provides said two-axis translation of the arm 14 of the robot 12, due to a combination of linear movement of the actuators 16A, 16B, 17 against said links 15A, 15B, 15C and the pivoting axes/hinges 15X, 15Y and XX of the four-bar linkage style articulation mechanism 15.

It will be appreciated that in some embodiments, other linkage styles or configurations may be employed for the articulation mechanism 15 of the robot 12, instead of the four-bar linkage shown in the figures. For example, a pivoting turntable (i.e., ‘turret-style’ mechanism) may be employed at the base of an embodiment robot, with a series of elongate arms extending therefrom and each connected via single-axis pivots/hinges, to provide a three-axis translation and single axis rotation (i.e., rotation of the turntable about the vertical axis) capability to the robot instead of the two-axis translation of the embodiment robot(s) 12 shown in FIG. 12.

In further embodiments, the articulation mechanism of the robot may even take the form of a fully articulated series of elongate arms each connected via 3-axis rotary joints, so as to provide both rotation and translation through all three axes.

Moreover, some embodiment robot(s) may comprise of a single articulation mechanism, taking any of the form(s) mentioned above, but having a plurality of arms 14 moved by the single mechanism. Such multi-arm embodiment robots may for instance advantageously employ a coordinated operation of both arms for guiding the barrier strap(s) 9 with one arm and simultaneously installing them to the posts 8 with the other arm.

In the configuration of operation of the barrier installer of the present invention where the barrier installer is able to install each of, or at least two of, the three products as described above, the robot is able to reconfigure or be reconfigured or adapted for the handling of each of the three products.

In a first configuration of the robot 12, as seen in FIGS. 3 to 5, an anchor driving tool 16 may be located at the distal end of the arm 14. The anchor driving tool 16 is preferably able to releasably secure to the end of the arm 14 of the (or each) robot 12 and is provided for placing an anchor 7 into the ground along the array 6. The anchor driving tool 16 may be pivotably engaged to the arm about the hinge axis XX as seen in FIG. 12 and its angle of rotation may be controlled by a respective actuator 17 (such as a hydraulic ram). The tool anchor driving tool 16 may preferably also able to pick a ground anchor 7 that is presented, having been dispensed from the store of ground anchors 10A, manipulate the ground anchor 7 into position (via movement of the articulation mechanism 15 about axes L1, Y1) and present it for being driven into the ground.

In the embodiments shown, the anchor driving tool 16 is able to rotate about the hinge axis XX from a position where it can pick a ground anchor 7 that is presented substantially horizontally as seen in FIG. 12, to a position where the ground anchor is presented substantially vertically as seen in FIGS. 4 and 5. Thus together with the arm 14, a ground anchor 7 received and held by the anchor driving tool 16 may be able to be positioned relative to the base 13, and preferably able to be presented substantially vertically in location as part of the array. The anchor driving tool 16 may include a hydraulic motor for rotating the ground anchor for screwing it into the ground.

In some embodiments, the arm 14 is telescopic or able to be otherwise elongated or caused to move along its elongated direction to apply a force to the ground screw 7 as it is being driven into the ground. A hydraulic system (not shown) may be used for controlling the telescopic movement of the arm 14. The telescopic arm movement can be seen illustrated in FIGS. 4 and 5, where the anchor driving tool 16 is seen vertically lower about the vertical axis Y1 in FIG. 5 with the arm 14 telescopically elongated accordingly.

In some embodiments, the telescoping of the arm 14 preferably applies an axial force to the ground screw anchor 7 (i.e., downwardly through said vertical axis Y1), although in some configurations the axial force may be provided by a movement of the tool 16 relative to the arm 14 in the axial direction of the ground screw anchor 7 or the ground screw 7 itself may draw itself into the ground as it is rotated.

As previously mentioned, the ground screw anchor 7 may instead be a ground anchor and may be driven into the ground using, for example, vibration. In which case, the anchor driving tool 16 may be a vibrational head that can hold and vibration drive a ground anchor into the ground. The anchor driving tool 16 is able to pick, manipulate and release the ground anchor 7 once it is placed in the array in the ground i.e., depressed and installed into the ground surface of the carriageway or road.

Where the tool is an anchor driving tool 16, a hydraulic auger drive may be utilised for applying a rotational torque to a ground screw anchor 7 and together with the arm to cause a downward pressure to be applied to the ground screw anchor 7 for anchoring this into the ground.

To ensure that each ground anchor 7 is placed accurately in its array, the robot 12 is preferably able to be controlled for movement relative to the base 13. Hence, even if the prime mover is not accurately positioning the product supporter 4 and work station 3 parallel to the array 6 at a fixed distance along the array, the robot 12 is preferably able to compensate for such deviation(s), if present.

The road barrier installer or system of the present invention is preferably able to accurately determine the correct installation position of a ground anchor 7 prior to it being driven into the ground to ensure it is being driven into the ground along a pre-programmed array and at a certain distance to the other ground anchor or anchors of the array.

In a preferred form, the prime mover 2 is able to ensure that the spacing between the anchors 7 of the array 6 is accurate.

In some embodiments, the installer or the system of the present invention is able to measure the distance of travel in order to ensure that the prime mover 2 travels or advances at desired increments along the array 6.

In some embodiments, the prime mover is able to be controlled for movement along said array at say, for example, six metre increments at where it will then pause for a ground anchor 7 or a pair of ground anchors 7 to be installed by the robot or robots 12 of the work station 3.

Moreover, a hydraulic or electric motor with an encoder may be used to control the forward movement of the prime mover 2 and may further control its movement at predetermined distance increments (such as six metres) for it to then pause for the product installation process to occur, whether that be ground anchor installation, post installation and/or barrier strap installation.

Alternative means for measuring these increments may be utilised and such may include a laser distance measuring or other measuring device, and may utilise GNSS or a local reference such as a reference post or a previously installed product of the array such as a previously installed ground anchor 7 or post 8. Where two robots are used these may be spaced apart at a three meter distance apart (along a length of the work station 3/trailer 5 of the installer 1) so that at each six metre increment of movement of the prime mover along the carriageway, two anchors are placed so that a plurality of three meter spaced apart anchors 7 positioned at six meter increments along the array 6 are provided.

An operator of the prime mover 2 may be involved in the programmed operation i.e., timed movement of the installer 1, by approving the completion of the work done at each pause or installation increment before the installer 1 is advanced by the prime mover 2 to its next position in the array for subsequent operation(s).

Alternatively, this timed movement of the installer 1 may also be automated and the pause(s) or installation increment(s) and/or duration(s) thereof may be determined by an automated process that determines the adequate completion of each of the installation step(s).

In order to help ensure that each product is placed in a direction lateral to the direction of travel of the prime mover 2, the distance of the arm 14 and in particular at where a tool such as the anchor driving tool 16 is secured to the arm 14, is preferably able to be determined or controlled.

In some embodiments, this may be achieved by the use of a level sensor 18 and, for example, a GNSS antenna 19. The antenna 19 may be utilised as part of a control system for ensuring that the arm 14 is positioned appropriately to a required or predetermined GNSS position.

The level sensor 18 and/or antenna 19 may together be utilised to action appropriate movement of the articulation mechanism 15 of the robot 12, such that the arm 14 is moved through the lateral axis L1 and vertical axis Y1 and/or it's movement(s) and position(s) appropriately adjusted as well, to ensure correct and true positioning of the distal end of the arm 14 i.e., of a tool connected thereto and thus product held thereby.

For instance, the arm 14 may be manoeuvred with its vertical and lateral orientations determined by the use of the level sensor 18 and/or antenna (as part of a control system) adjusting operation of the actuators 16A, 16B, 17 of the articulation mechanism 15. The telescopic elongation of the arm 14 may also likewise be controlled via a combination of the level sensor 18 and/or antenna 19 providing real-time inputs and measurements to a control system.

Such control system(s) or method(s) may for instance ensure that the arm 14 is substantially vertical immediately prior to the installation of a ground anchor 7.

Such a control system may for example comprise a closed-loop multiple-variable feedback system that actively measures and monitors a plurality of parameters such as angular or translational positions, elevations and/or orientations of the robot 12 and its components, to determine the position of a connected tool and/or held product, relative the installer 1 (i.e., height relative the work station 3, lateral distance therefrom etc.) and/or relative the carriage way surface i.e., relative the array, a specific installation location, height above the ground-level, and the like.

Various other control methods and schemes known in the art may be employed to action appropriate positioning of the robot 12 and/or to action, sequence and/or adjust any other function(s) of a given installer embodiments, such as, for instance, a programmable logic controller (PLC).

Moreover, said control system(s) may also passively collect data during operation, such as installation location coordinates, time of installation (i.e., of each screw or post or strap), torque required for installation of a given screw 7, and/or any other measurable or recordable data points which may provide a record of work completed and may also assist in refining future operations.

The arm 14 can then be telescopically extended under guidance from the control system and the tool 16 operated to drive the anchor into the ground until the ground screw top is at a desired level.

This level may be a level of the surface of the ground or may be above or below said surface. The level may be determined by GNSS as described previously, or a local positioning sensing and/or measuring system. In the configuration of operation of the barrier installer where the work station is able to be reconfigured for the handling of different of said product (i), (ii). (iii) as mentioned above, the arm or arms 14 are able to receive and substitute different tools for handling each of the different products mentioned above.

As can be seen in FIG. 6, a post connection tool 20 has been coupled to the distal end of the arms 14 of each of the two robots shown. The post connection tool 20 is able to, in a preferred form, hinge relative to a respective arm and may be caused to hinge about the axis XX described above for the purposes of selecting and receiving/holding a post 8, and then manoeuvring the held post 8 to a position for connection to an already-installed ground anchor 7.

The post connection tool may be able to be controlled for movement in a manner as described with reference to the anchor driving tool 16.

In some embodiments, a store of ground screw anchors 10A may be supported or arranged atop/on/within the product supporter 4 in a horizontal condition or orientation. As seen for example in FIG. 9, a ground screw anchor 7 of the store of ground screw anchors 10A, is oriented horizontally.

The store of ground screw anchors 10A may include one or more ground screw anchor storage racks 28A, where a plurality of said ground screws 7 are oriented horizontally, atop and below i.e., vertically aligned with one another, in parallel/adjacent columns of said horizontally oriented ground screws.

Each column of these racks 28A may define a re-fillable and removable magazine of the rack 28A.

In some embodiments, as shown in FIG. 9 and more clearly in FIG. 10 the store of ground screws 10A may comprise two rows of thirty-five of said racks or magazines 28A, each having eighteen ground screws 7, the two rows of thirty-five racks arranged adjacent each other within, for example, a 20 ft high cube shipping container. Said embodiment store of ground screws 10A therefore containing 1260 ground screws 7.

As seen in FIG. 9, there may be two horizontal dispensary rows 29A, 29B positioned beneath the storage racks 28A of the store of ground screws 10A.

These dispensary rows 29A, 29B may position a plurality of ground screws 7, dispensed from said storage rack(s) 28A, in a horizontal adjacent and parallel orientation, i.e. side by side each other, within the width of said store of ground screws 10A (which may, for example be the standard width of a truck trailer and/or shipping container).

The ground screw storage racks 28A allow for ground screw anchors 7 to be dispensed therefrom, in a sequential manner, from the bottom of said rack(s) 28A, where a column or stack of ground screws 7 iteratively lowers through a magazine i.e., in a downward sequence, as the bottom-most ground screw thereof is dispensed from the rack.

As shown in FIG. 14 the bottom-most rows of each of the thirty-five magazines 28A of ground screws 7, when so-held in these vertical racks 28A, are prevented from descending under the force of gravity by hooks 50.

When ground screws 7 are required to be dispensed onto dispensary rows 29A, 29B, elongate lifting beams 51 disposed on flanks of the (planar rolling surface of the) dispensary rows 29A, 29B, shown in FIG. 14, are actuated to lift the entire store of ground screws 10A, i.e., both rows of the thirty-five magazines/racks 28A, such that the weight of the screws 7 is no longer imparted on the hooks.

Thereafter, the hooks 50 may be momentarily released into their open position, (shown in their closed position in FIG. 14), with the lifting beams 51 then lowered until the bottom-most screw 7 of each magazine 28A, now resting/supported atop said lifting beams 51, clears (moves below) the hooks 50, said lifting beams 51 being dimensioned to be shorter in length than the screws 7 to provide support for them thereatop.

The hooks 50 are then reactivated into their closed position, to capture the second-from-the-bottom plurality of ground screws 7 of each magazine 28A (i.e., the screws 7 that reside atop the group that were received by said lifting beams 51) from being dispensed.

The lifting beams 51 then lower to a height beneath a planar rolling surface of the dispensary rows 29A, 29B, such that the newly dispensed screws 7 resting thereatop become supported/disposed on the planar rolling surface of the dispensary rows 29A, 29B instead.

Also shown in FIG. 9 is a transfer or conveyor arrangement 30 that permits the transfer or conveyance of aa ground screw anchor 7 from the store of ground screw anchors 10A to the work station 3. As will be described hereinafter, said transfer arrangement 30 may also be employed in the transfer or conveyance of post(s) 8 from a store of posts 20B to the work station 3.

The transfer arrangement 30 is shown comprising a receipt mechanism 30A mounted atop laterally extending rails 30B. The receipt mechanism 30A may therefore slidingly translate across the width of the work station 3, so as to retrieve ground screws 7 from either of the two dispensary rows 29A, 29B.

The dispensary rows 29A, 29B may comprise conveyer means, (such as a rolling, endless belt or track arrangement etc.) to convey ground screws 7 longitudinally to a location adjacent the rails 30B, for retrieval by the receipt mechanism 30A.

Actuation of the receipt mechanism 30A is actioned by actuator 30C that rotates the jaw 30D of the receipt mechanism 30A from one side thereof (i.e., to retrieve a ground screw 7 from either of the two dispensary rows 29A, 29B) to the other side thereof (i.e., to dispense said ground screw 7).

Mounted adjacent said rails 30B, is a conveyer 31 extending longitudinally (i.e., along the length of the work station 3). Said conveyer 31 may take the form of a rolling, endless belt or track arrangement, or any other suitable mechanism or means know in the art. The receipt mechanism 30A may thus dispense the retrieved ground screw 7 therefrom onto said conveyer, by actuation of said actuator 30C/rotation of said jaw 30D.

The conveyor 31 preferably conveys one or more dispensed ground screws to a location where said ground screw(s) presented by the conveyor are able to be retrieved by the anchor driving tool 16. The anchor driving tool 16 may then select a so-positioned ground screw anchor 7 from the conveyer, couple/connect to it, and then manoeuvre it for installation as previously described.

The above described arrangement and functionality of the racks or magazines 28A and dispensary rows 29A, 29B may apply equally when a store of posts 8 is loaded onto the product supporter 4.

An example store of posts 10B can be seen in FIG. 13 having substantially the same configuration as the store of ground screws 10A described above, except instead of two rows of thirty-five magazines or racks 28A, the longer length of a given post 8 compared to a ground screw 7 is such that only a single row of thirty-five magazines or racks 28B may fit within a 20 ft high cube shipping container. Such a store of posts 10B may be able to house enough posts 8 for coverage of 3000 meters of length of the array/barrier.

However, the operation of the hooks 50 together with the lifting beams 51 and thus dispensing of the bottom-most post 8 of each of the thirty-five magazines or racks 28B onto a single dispensary row (not shown in FIG. 13, but may be configured as a conveyer similar to the rows 29A, 29B of FIG. 9) may follow the same general procedure as that described above in relation to FIGS. 9 and 14 i.e., in relation to ground screw 7 dispensing shown. The receipt mechanism 30A and conveyor 31 may also be likewise utilised for conveying posts 8 from said single dispensary row, into position for their engagement by the post connection tool 20.

The conveyer 31 may extend longitudinally underneath archway(s) 12C of the robot(s) 12 as shown in FIG. 13.

In some embodiments, a grabber (not shown) may be positioned at said archways and configured to clasp and then elevate a post 8 or ground screw 7 from the conveyer 31 to a height for receipt by (the appropriate tool connected to) the distal end of the arm(s) 14 of the robot(s) 12. Such a grabber or grabbers may do so with use of a spring or otherwise-actuated clamp.

However, in some embodiments, the arm(s) 14 themselves may simply extend downwardly sufficiently so as to retrieve a post 8 or ground screw 7 from the conveyer 31.

The example storage, dispensing and transfer means described above (i.e., the configuration and arrangement of the racks 28A, 28B, dispensary rows 29A, 29B, transfer arrangement 30, receipt mechanism 30A and conveyor 31) will be appreciated by those skilled in the art as only an illustrative means of moving product(s) from the product supporter 4 to the work station 3, for handling by the at least one robot 12.

Other conveyance and handling means may equally be employed to transfer product from the product supporter 4 to said work station 3.

Preferably however, said transfer arrangement 30, and optionally said store of product 10, is configured to be multi-functional or modular such that it may be used in the transfer of product from the product supporter 4 to said work station 3 irrespective of the product(s) required for transport and/or the arrangement or configuration of said work station 3.

In a preferred mode of operation of the installer and system a first pass may comprise ground screw anchor 7 installation, as previously described. Both robot(s) 12A, 12B may be employed in this phase, installing pairs of ground screws 7 at distances from one another equivalent to the longitudinal distance between said robots 12A, 12B, with each pair distanced at six meter or other increments along the carriageway. A single ‘cycle’ of said first pass may comprise of at least the steps of:
a) the installer 1 coming to a half before, during or after the robots 12A, 12B each retrieving a respective ground screw 7 from the conveyer 31,
b) said robots 12A, 12B moving said screw anchors 7 into location as determined by previously described control systems and/or by level/GNSS sensors/antennae,
c) said robots 12A, 12B driving said screw anchors 7 into the ground, to their correct level, and
d) the installer 1 beginning movement to the next installation location,

A single cycle of the first pass may have a duration of about 40 to 60 seconds.

The ground screw anchor tool or tools 16 may then be replaced by the post connection tool or tools 20 and the store of ground screw anchors 10A may be removed and replaced by a store of posts 10B.

In a second pass the post connection tool or tools 20 in a similar manner pick posts 8 from the conveyer 31 and position them for installation to respective installed ground anchors 7. In embodiments where a single installer 1 is used and re-used for each pass, the second pass may be in a direction reversed to the first pass or may be in the same direction where the installer has been driven back to the start of the first pass and location.

Following the second pass, the post connection tool or tools 20 may be removed from the arms 14 and may be replaced by equipment or tools capable of installing the barrier strap or straps 9, such as the strap guide tool 50 and/or strap fastener tool 51 described below. The store of posts 10B may be removed and a store of barrier straps 10C may be installed to the product supporter 4.

The barrier strap or straps may be presented in the store as a reel or reels 40A, 40B as for example seen in FIG. 11. Said reels 40A, 40B may comprise of rotatable wheels 41 having several windings or laps of at least one or more barrier strap(s) 9 extending around their circumference. Said reels may be described as bobbins or substantially cylindrical members about which the strap or straps are wound in a coiled format.

These reels 40A, 40B may be oriented as shown (with their rotation axes horizontal), such that they dispense said at least one barrier strap 9 from near the top of said store of straps 10C (i.e., top of the 20 ft high cube shipping container housing said reels 40A, 40B).

The store of barrier straps 10C may also comprise of several alignment guides 42 that help keep the one or more straps 9 being disposed from said reels 40A, 40B in correct alignment. The dispensed barrier strap or straps 9 may thus travel over the work station 3 and/or robots 12 thereof as seen in FIG. 7 and out from an orifice 3A of the work station 3. The dispensed strap(s) 9 may then be received and manipulated by the strap guide tool 50 connected to the distal end of one arm 14 of the first robot 12A into the appropriate position relative the already installed posts 8, with the strap fastener tool 51 being configured to secure said dispensed strap(s) 9 to the posts 8 of the array 6.

The strap guide tool 50 may comprise of a pulling mechanism that pulls the strap(s) 9 through a slot of the tool. Alternatively, or additionally, the strap(s) 9 may be otherwise actuated or actioned to move from the reels 40A, 40B to be dispensed external the installer 1. For instance, some embodiments may comprise actuated reels 40A, 40B, i.e., motorised at their rotatable shafts to dispense said strap(s) 9.

The strap fastener tool 51 may comprise of air or otherwise-actuated guns that propel fasteners from within said tool 51 through the strap(s) 9 and into the posts 8, for securement of the strap(s) 9 thereto. Alternatively, or additionally, the strap fastener tool 51 may comprise a retainer dispenser which sandwiches said strap(s) in between retainers and the posts 8 by virtue of the retainers being affixed to the posts 8 via said strap fastener tool 51.

In some embodiments, a single strap tool (not shown) may be provided for both guidance and installation of the strap(s) 9 to the post(s) 8.

In some embodiments, an installer 1 may be equipped and/or house or store a plurality of different tools, such as the anchor driving tool(s) 16, post connection tool(s) 20, strap guide tool(s) 50 and/or strap fastener tool(s) 51.

An embodiment installer 1 may carry all of the anchor driving tool(s) 16, post connection tool(s) 20, strap guide tool(s) 50 and/or strap fastener tool(s) 51.

Preferably, an embodiment installer 1 carries all of: at least one anchor driving tool(s) 16, at least one post connection tool(s) 20, at least one strap guide tool(s) 50 and at least one strap fastener tool(s) 51, within the work station 3 such that the robot(s) 12A, 12B may easily interchange between said tools without external input/assistance.

In some embodiments of the installer 1, its work station 3 may comprise (i.e., house and/or be configured to store or house) all of: at least one anchor driving tool(s) 16, at least one post connection tool(s) 20, at least one strap guide tool(s) 50 and at least one strap fastener tool(s) 51 while its product supporter 4 comprises a store of product 10 having at least one of each of: a ground screw 7, a post 8 and a strap 9. Such an embodiment installer 1 may thus easily switch to and from and between: a ground screw installation condition/configuration, a post installation condition/configuration and a barrier strap installation condition/configuration, as described above.

In some embodiments, video recording and display means, such as cameras and the like may be employed to view the operation and components used for the present invention.

When a truck 2A is employed as the prime mover, these displays may present live images in the cab 2B of the truck 2A, allowing an operator therein to view the video footage during installation/operation and thus provide oversight. This may be useful in allowing said operator to halt operations when there is a malfunction or an inevitable danger arising i.e., a vehicle or object travelling in a direction of the installer's path along the array/carriageway.

In the event of a malfunction or an inherent danger arising, the operator can manually override all functions and cease operation of the installer.

It is envisaged that the installer is able to travel at a speed and install the products previously described, and thereby erect at least a 200 meter length of the array/road-safety barrier every hour, if not a 300 or 400 meter length of the array/road-safety barrier every hour.

In some embodiments, the installer may have capacity to carry enough product(s) for erection of about 2000 meters of barrier.

Embodiments of the road safety barrier installer 1 described herein, as well as the associated system(s) and method(s), may therefore be appreciated or understood as providing a multi-functional, modular, self-contained/independent and autonomous means of installing a road-safety barrier, wherein:
the embodiment installer may be multi-functional by virtue of its capacity to not only carry any of the products (i), (ii), (iii), but to also install any of the products (i), (ii), (iii) without external i.e. road-side machine or human input or assistance, i.e., wherein:
   the installer may be configured to be switchable to and from: a ground screw installation condition or configuration, a post installation condition or configuration and/or a barrier strap installation condition or configuration, as described above,
   the installer may be configured to comprise any one or more of the example tool(s) that may be employed in product installation, such as: anchor driving tool(s) 16, at least one post connection tool(s) 20, at least one strap guide tool(s) 50 and at least one strap fastener tool(s) 51, and
   the installer may be configured to comprise a store of any of a plurality of ground screws, posts or straps, and/or may be configured to comprise a store of two or more of at least one ground screw, at least one post and/or at least one strap,
the embodiment installer may be modular in that:
   it's various components can be adapted as per standardised dimensions such as by use of a standard truck, a standard trailer, with the work station and store of product employed being of a standard shipping container size/shape, and
   thus, can be interchanged accordingly i.e., the truck, trailer, and store(s) may all by swapped, re-used etc. as a result of their standardised configuration, also thus providing ease of storage, transport, handling/movement/lifting of said components,
the embodiment installer may be self-contained/independent due to a combination of the above, in that it requires no external input or assistance and also is easily adaptable and contained within standardised specifications,
the embodiment installer may be autonomous in that it make carry out all the above functionality with minimal manual input, with only remote or minimal local supervision, and employ any known control system means for automatic and accurate sequencing of the necessary events/operations as well as data recording for record keeping and refinement, and the like.

Those skilled in the art will appreciate how the above combination of properties of the present invention may provide advantages such as speed and accuracy of installation, ease of transport/adaption to and from work-sites, increased safety due to lack of external input or assistance and decreased interference to the use of a road, all of which may together result in an increased likelihood of compliance with relevant regulations/laws.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A multi-function road safety barrier installer for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array parallel to the road to define at least part of a road safety barrier, the road safety barrier installer comprising:
a. a prime mover able to travel along a road adjacent to an installation location where the road-safety barrier is to be installed,
b. a work station, able to move with and by the prime mover along the road adjacent to the installation location, the work station comprises a base and at least one placement robot able move relative to the base,
c. a product supporter, able to be moved by the prime mover with said work station along the road adjacent to the installation location, wherein the product supporter is adapted for storing, transporting and supplying to said at least one placement robot a plurality of ground screws and a plurality of posts and at least one barrier strap from at least one store containing at least one of:
i. a plurality of ground screws,
ii. a plurality of posts, and
iii. at least one flexible barrier strap in a coiled format,
able to be supported simultaneously or sequential by said product supporter, to allow the sequential supply of ground screws and posts and barrier strap to said at least one placement robot to install in location adjacent said road, said ground screws and posts and said barrier strap.

2. The multi-function road safety barrier installer as claimed in claim 1, wherein the product supporter is adapted for storing, transporting and supplying to said at least one placement robot a plurality of ground screws and a plurality of posts and at least one barrier strap from at least two stores a first store containing a plurality of ground screws and a second store containing a plurality of posts, the first or second store also containing at least one flexible barrier strap in a coiled format.

3. The multi-function road safety barrier installer as claimed in claim 1, wherein the product supporter is adapted for storing, transporting and supplying to said at least one placement robot a plurality of ground screws and a plurality of posts and at least one barrier strap from at least two stores a first store containing a plurality of ground screws and a second store containing at least one flexible barrier strap in a coiled format, the first or second store also containing a plurality of posts.

4. The multi-function road safety barrier installer as claimed in claim 1, wherein the product supporter is adapted for storing, transporting and supplying to said at least one placement robot a plurality of ground screws and a plurality of posts and at least one barrier strap from three stores a first store containing a plurality of ground screws and a second store containing a plurality of posts and a third store containing at least one flexible barrier strap in a coiled format.

5. A road safety barrier installer for installing an array of ground screw supported spaced apart posts that in concert support at least one barrier strap that extends along the array, the road safety barrier installer comprising:
a. a prime mover able to travel along a road adjacent to the location of the array,
b. a work station, towed by or part of or otherwise able to move with and by the prime mover, along the road adjacent to the location of the array,
c. a product supporter, towed by or part of or otherwise able to move with and by the prime mover and/or the work station, along the road adjacent to the location of the array, wherein the product supporter is adapted to receive one of
a. a single store of a plurality of product comprising of one of
i. barrier strap and ground screws, and
ii. barrier strap and posts,
b. a plurality of stores, individually, of a plurality of product comprising of one of:
i. barrier strap and ground screws, and
ii. barrier strap and posts, and
wherein the work station comprises:
i) a base, towed by or part of or otherwise able to move with and by the prime mover, and
ii) at least one placement robot able move relative to the base, the robot able to receive and manipulate a plurality of tools each selected to receive and hold a respective said product, and position the so received and held product in location as part of the array, wherein one of said plurality of tools is a barrier strap connection tool able to receive a continuous feed of barrier strap and able to move the barrier strap to position and secure the barrier strap at a predetermined height to each post of the array.

6. The road safety barrier installer of claim 5, wherein the prime mover is able to travel on at least one of the carriage way of the road, the berm to the road, the median strip of the road, and/or the emergency lane of the road.

7. The road safety barrier installer of claim 5, wherein the prime mover comprises an electrically-powered or fossil-fuel-powered truck with a truck body presenting a cabin and a cargo area or towed trailer with a cargo area to the rear of the cabin, wherein the cargo area is where at least the work station is positioned.

8. (canceled)

9. (canceled)

10. The road safety barrier installer of claim 5, wherein the prime mover is able to be automatically steered.

11. The road safety barrier installer of claim 5, wherein the prime mover is able to be automatically steered utilising a satellite positioning system.

12. The road safety barrier installer of claim 5, wherein one or more of each store of plurality of product is a containerised store.

13.-17. (canceled)

18. The road safety barrier installer of claim 5, wherein a transfer arrangement is provided to transfer product from the containerised store to a respective tool of a plurality of tools.

19. The road safety barrier installer of claim 18, wherein one of said plurality of tools is a ground screw driving tool, wherein the ground screw tool is able to cause a connected ground screw to rotate relative to the robot to cause the ground screw to embed into the ground at a desired location along the array.

20.-27. (canceled)

28. A road safety barrier installation system for installing an array of ground penetrating anchor supported spaced apart posts that in concert support at least one barrier strap that extends along the array, the road safety barrier installation system comprising:
a. a work station, able to be guided for movement along the road adjacent to the location of the array,
b. at least one product supporter able to be guided for movement along the road adjacent to the location of the array, coupled to or integrally formed or connected with the work station, wherein the product supporter is adapted to receive one of
a. a single store of a plurality of product comprising of one of
i. barrier strap and ground screws, and
ii. barrier strap and posts,
b. a plurality of stores, individually, of a plurality of product comprising of one of:
i. barrier strap and ground screws, and
ii. barrier strap and posts,
and
wherein the work station comprises of at least one placement robot able move relative to the base, the robot able to receive and manipulate a plurality of tools each selected to receive and hold a respective said product and position the so received and held product in location as part of the array, wherein one of said plurality of tools is a barrier strap connection tool able to receive a continuous feed of barrier strap and able to move the barrier strap to position and secure the barrier strap at a predetermined height to each post of the array.

29. (canceled)

30. A method for installing a road safety barrier that when installed, comprises of an array of a plurality of ground screws supported in ground adjacent a road and a plurality of posts supported by said plurality of ground screws and at least one flexible barrier strap secured to the plurality of posts and extending along the array parallel to the road to define at least part of a road safety barrier, the method comprising:
i. together guiding: (i) a product supporter and (ii) at least one placement robot, along the road adjacent to the location of the array in a sequence of passes, wherein:
a. in a first pass along the road, the product supporter comprises a plurality of ground screws and the at least one placement robot is adapted for positioning and installation of the plurality of ground screws during said first pass,
b. in a second pass along the road in the same or opposite direction as the first pass, the product supporter comprises a plurality of posts and the at least one placement robot is adapted for positioning and installation of the plurality of posts to the installed plurality of ground screws, during said second pass, and
c. in a third pass along the road in the same or opposite direction as the first and/or second pass, the product supporter comprises at least one barrier strap and the at least one placement robot is adapted for positioning and installation of the at least one barrier strap to the installed plurality of posts, during said third pass.

31. A road safety barrier installation system for installing an array of ground penetrating anchor supported spaced apart posts that in concert are able to support at least one barrier strap or cable that extends along the array, the road safety barrier installer system comprises:
a) a work station, able to be guided for movement along the road adjacent to the location of the array,
b) at least one product supporter able to be guided for movement along the road adjacent to the location of the array, coupled to or integrally formed or connected with the work station,
i. wherein the product supporter is adapted to be able to support a store of a plurality of ground penetrating anchors and posts, and
ii. wherein the work station comprises at least one placement robot that comprises and arm and a tool at the end of the arm and is able to individually
a. receive and hold a said ground penetrating anchors and posts using tool, and
b. position the so received and held ground penetrating anchors and posts in location as part of the array.

32. A system as claimed in claim 31 wherein the robot can apply a vertical pressure to a ground screw held by the tool to help cause the ground screw to penetrate into the ground.

33. A system as claimed in claim 31 wherein the arm includes a level sensor that communicates with an actuator that can control the angle of the arm to ensure the tool causes the ground screw to penetrate the ground vertically.

34. A system as claimed in claim 33 wherein a second sensor is provided that is a location sensor to help determine the position of the arm relative to a reference point or location.

35. A system as claimed in claim 34 wherein the second sensor communicates with an actuator that can control the position of the arm.

36. A system as claimed in claim 35 wherein the second sensor communicates with an actuator that can control the position of the arm to ensure the ground screw and/or post is positioned at an appropriate location to the ground during the locating of the ground screw and/or post into the array.
